(19) United States
(12) Patent Application Publication
(10) Pub. No.: US 2025/0115808 A1
(43) Pub. Date: Apr. 10, 2025

(54) METHODS FOR PREPARING LUMINESCENT MATERIALS FROM PLASTIC MATERIALS

(71) Applicant: Rutgers, The State University of New Jersey, New Brunswick, NJ (US)

(72) Inventors: Yongqi Yang, Piscataway, NJ (US); Deirdre M. O’Carroll, Metuchen, NJ (US)

(73) Assignee: Rutgers,The State University of New Jersey, New Brunswick, NJ (US)

(21) Appl. No.: 18/907,104

(22) Filed: Oct. 4, 2024

Related U.S. Application Data
(60) Provisional application No. 63/542,898, filed on Oct. 6, 2023.

(51) Int. Cl. C09K 11/65

(52) U.S. Cl. CPC C09K 11/65

(57) ABSTRACT

The present disclosure relates, in part, to a method for preparing a carbon nanomaterial from a plastic material. In certain embodiments, the method comprises nonsolvent induced phase separation of the plastic material to provide plastic nanoparticles. In certain embodiments, the method comprises hydrothermal conversion of the plastic nanoparticles to carbon nanomaterials. In certain embodiments, the plastic material is derived from waste material. In certain embodiments, the plastic material is polypropylene (PP). In certain embodiments, the carbon nanomaterial is carbon dots (CDs). In another aspect, the disclosure provides a method for altering the properties of CDs by post-processing to afford graphitic materials.

### CROSS-REFERENCE TO RELATED APPLICATIONS

This application claims priority under 35 U.S.C. § 119 (e) to U.S. Provisional Patent Application No. 63/542,898, filed Oct. 6, 2023, which is incorporated herein by reference in its entirety.

### BACKGROUND

Plastic waste is a serious environmental concern, as it is one of the largest pollutants worldwide. Plastic waste degrades slowly, contaminating the environment in the long term, necessitating immediate action. Macroplastics normally degrade into microplastics (MPs) and nanoplastics (NPs) that are small enough to be consumed by primary consumers in ecosystems and enter food chains. However, less than 10% of the world's produced plastic is recycled, while the rest ends up in landfills and in the ecological environment. Human consumption of MPs from marine food sources and everyday food packaging is especially concerning. For example, it is estimated that Americans consume 39,000 to 52,000 MP particles annually.

The heat-resistance and superior mechanical properties of polypropylene (PP), as compared to other plastics, have made it a popular material, especially for single-use container packaging and bottles. PP MPs are also prevalent in common personal care products and are difficult to remove in wastewater treatment facilities. PP accounts for 16% of the worldwide plastics market and is prevalent in marine environments due to its low density, allowing wind and water currents to distribute and erode it. This leads to a large amount of PP nanoplastics in the environment.

Current plastic waste recycling methods have many drawbacks. When plastic is recycled, its quality and durability decrease when compared to virgin plastic material. Also, current infrastructure cannot handle plastic composites commonly found in food packaging in which PP and polyethylene terephthalate (PET) are layered together. This is because different kinds of plastics need to be separated and sorted before going through separate recycling processes; the composite nature makes this exceedingly difficult. Still, few methods to recycle PP exist in the first place, allowing large amounts of PP to contaminate the environment.

Thus, there is a need in the art for methods of sequestering plastic waste materials, including methods of preparing carbon dots (e.g., luminescent carbon dots) and/or carbon nanomaterials or graphitic-like materials by post-processing thereof. The present disclosure addresses this need.

### BRIEF SUMMARY

In one aspect, the disclosure provides a method for preparing a carbon nanomaterial from a plastic material. In certain embodiments, the method comprises heating a first mixture comprising a plastic material and a first solvent to provide a first solution, wherein the first solvent comprises a nonpolar or low polarity solvent. In certain embodiments, the method comprises contacting the first solution with a polar solvent to provide a second mixture. In certain embodiments, the method comprises isolating plastic nanoparticles from the second mixture by removing at least a portion of the solvent in the second mixture. In certain embodiments, the method comprises suspending the isolated plastic nanoparticles in an oxidizing solvent to provide a third mixture. In certain embodiments, the method comprises heating the third mixture in a sealed vessel to provide a fourth mixture comprising the carbon nanomaterial, wherein the heating of the third mixture occurs at a temperature ranging from about 100° C. to about 200° C. for a period of about 1 h to about 24 h.

In certain embodiments, the method further comprises purification of the carbon nanomaterial. In certain embodiments, the method further comprises post-processing of the carbon nanomaterial. In certain embodiments, the carbon dot is substantially free of the plastic material.

In another aspect the disclosure provides a carbon nanomaterial prepared according to the method of the disclosure.

### BRIEF DESCRIPTION OF THE FIGURES

The drawings illustrate generally, by way of example, but not by way of limitation, various embodiments of the present application.

FIGS. 1A-1B provide schematics depicting non-limiting, exemplary processes according to the methods of the present disclosure for the conversion of polypropylene (PP) into carbon dots (CDs). FIG. 1A provides a schematic showing pre-processing of an exemplary PP source (e.g., PP pellets and/or PP waste) by non-solvent induced phase separation (NIPS) to provide PP nanoparticles. FIG. 1B provides a schematic showing hydrothermal conversion of PP nanoparticles to PP CDs.

FIG. 2 provide a photograph depicting vials containing CDs obtained according certain exemplary methods of the present disclosure having varied hydrothermal conditions (i.e., 120° C., 6 h; 120° C., overnight; 180° C., 6 h; 150° C., 6 h; and 120° C., overnight; from left to right).

FIG. 3 provides a graph showing the absorbance of 50 μL and 100 μL solutions of exemplary CDs of the present disclosure, prepared from PP pellets, in 2 mL of DI water at different wavelengths by UV-Vis spectroscopy.

FIG. 4 provides a graph showing the absorbance of a 100 μL solution of exemplary CDs prepared from PP pellets and a 100 μL solution of exemplary CDs prepared from PP waste at different wavelengths by UV-Vis spectroscopy.

FIG. 5 provides a graph showing the absorbance of 100 μL solutions of exemplary CDs prepared from PP pellets, wherein the CDs were prepared according to certain exemplary methods of the present disclosure having varied hydrothermal conditions (i.e., 120° C., overnight; 120° C., 6 h; 150° C., 6 h; and 180° C., 6 h) at different wavelengths by UV-Vis spectroscopy.

FIG. 6 provides a photoluminescence spectrum of certain exemplary CDs of the present disclosure prepared from PP pellets according to the methods described herein, wherein the hydrothermal treatment of the PP pellets comprises heating at 120° C. for 6 h. Intensity is highest at 450 nm.

FIG. 7 provides a photoluminescence spectrum of certain exemplary CDs of the present disclosure prepared from PP pellets according to the methods described herein, wherein the hydrothermal treatment of the PP pellets comprises heating at 150° C. for 6 h. Intensity is highest at 350 nm.

FIG. 8 provides a photoluminescence spectrum of certain exemplary CDs of the present disclosure prepared from PP pellets according to the methods described herein, wherein the hydrothermal treatment of the PP pellets comprises heating at 180° C. for 6 h. Intensity is highest at 350 nm.

FIG. 9 provides a photoluminescence spectrum of certain exemplary CDs of the present disclosure prepared from PP pellets according to the methods described herein, wherein the hydrothermal treatment of the PP pellets comprises heating at 120° C. for 14 h, and wherein measurement occurred immediately after filtration (Trial 1). Intensity is highest at 500 nm.

FIG. 10 provides a photoluminescence spectrum of certain exemplary CDs of the present disclosure prepared from PP pellets according to the methods described herein, wherein the hydrothermal treatment of the PP pellets comprises heating at 120° C. for 14 h, and wherein measurement occurred 48 h after filtration (Trial 2). Intensity is highest at 450 nm.

FIG. 11 provides a photoluminescence spectrum of certain exemplary CDs of the present disclosure prepared from PP waste according to the methods described herein, wherein the hydrothermal treatment of the PP waste comprises heating at 120° C. for 14 h. Intensity is highest at 450 nm.

FIG. 12 provides an overlay of photoluminescence spectra of exemplary CDs of the present disclosure prepared from PP pellets or PP waste according to the methods described herein, wherein the hydrothermal treatment of the PP pellets or PP waste comprises heating at 120° C. for 14 h. The overlay shows that, under these conditions, the CDs prepared from PP pellets exhibit a higher intensity at lower wavelengths and similar intensity at higher wavelengths, relative to CDs prepared from PP waste.

FIG. 13 provides an overlay of photoluminescence spectra of exemplary CDs of the present disclosure prepared from PP pellets according to the methods described herein under varied hydrothermal conditions (i.e., 120° C., 6 h; 150° C., 6 h; 180° C., 6 h; and 120° C., 14 h). Excitation wavelength 430 nm. The overlay shows that the CD prepared at 120° C. for 6 hours had the greatest intensity, whereas the CD prepared at 120° C. for 14 hours exhibited the second greatest intensity.

FIG. 14 provides an overlayed graph showing size distributions of CDs prepared from PP pellets or PP waste according to the methods described herein under varied hydrothermal conditions (i.e., PP pellets—120° C., 6 h; 120° C., 14 h; 180° C., 6 h; and 150° C., 6 h; and PP waste—120° C., 14 h).

FIG. 15 provides a graph showing size distribution of CDs prepared from PP pellets according to the methods described herein, with heating at 120° C. for 14 h.

FIG. 16 provides a graph showing size distribution of CDs prepared from PP pellets according to the methods described herein, with heating at 120° C. for 6 h.

FIG. 17 provides a graph showing size distribution of CDs prepared from PP pellets according to the methods described herein, with heating at 150° C. for 6 h.

FIG. 18 provides a graph showing size distribution of CDs prepared from PP pellets according to the methods described herein, with heating at 180° C. for 6 h.

FIG. 19 provides a graph showing size distribution of CDs prepared from PP waste according to the methods described herein, with heating at 120° C. for 14 h.

FIG. 20 provides a dark field microscopy image of CDs prepared from PP pellets according to the methods described herein, with heating at 180° C. for 6 h.

FIG. 21 provides a microscopy image (470 nm) of CDs prepared from PP pellets according to the methods described herein, with heating at 180° C. for 6 h.

FIG. 22 provides a dark field microscopy image of CDs prepared from PP waste according to the methods described herein, with heating at 120° C. for 14 h.

FIG. 23 provides a microscopy image (470 nm) of CDs prepared from PP waste according to the methods described herein, with heating at 120° C. for 14 h.

FIGS. 24A-24F provide scanning electron microscopy (SEM) and transmission electron microscopy (TEM) images of PP nanoplastics (NPs) and certain exemplary PP CDs. FIG. 24A: SEM of PP NPs (120° C.); inset: histogram of particle size distribution. FIG. 24B: SEM of PP CDs (120° C.); inset: histogram of particle size distribution. FIG. 24C: TEM of PP NPs; inset: cluster of PP NPs. FIG. 24D: TEM of PP CDs (120° C.). FIG. 24E: TEM of PP CDs (150° C.). FIG. 24F: TEM of PP CDs (180° C.).

FIG. 25 depicts UV-Visible absorption spectra of certain exemplary PP CDs dispersed in deionized (DI) H₂O. UV-vis absorption of diluted raw product, diluted raw product after centrifugation, diluted raw product after centrifugation and filtration (PP CDs), and diluted control experiment with only concentrated H₂SO₄.

FIGS. 26A-26D depict Fourier-transform infrared spectroscopy (FT-IR) and X-ray photoelectron spectroscopy (XPS) spectra of certain exemplary PP CDs. FIG. 26A: transmittance spectra of certain exemplary PP CDs prepared according to the methods described herein, with heating at 120° C., 150° C., and 180° C. FIGS. 26B-26D: XPS high resolution spectra of certain exemplary PP CDs prepared according to the methods described herein, with heating at 120° C., 150° C., and 180° C.; C 1s scan spectra (FIG. 26B); O 1s scan spectra (FIG. 26C); and S 2p scan spectra (FIG. 26D).

FIG. 27 depicts non-limiting illustrative chemical structures of CDs prepared according to the methods described herein under different heating conditions (i.e., 120° C., 150° C., and 180° C.).

FIG. 28: Raman spectra of PP-CDs-120, graphite and Si substrate with background subtraction on PP-CDs sample.

FIG. 29: XPS high-resolution spectra O 1s scan of PP-CDs-120, PP-CDs-150, and PP-CDs-180.

FIG. 30A: Size distribution by number of PP-NPs; inset: size distribution from 1 μm to 10 μm. FIGS. 30B-30D: Size distribution by number of PP-CDs from 120° C. (FIG. 30B), 150° C. (FIG. 30C) and 180° C. (FIG. 30D).

FIG. 31: Photographs of PP-CD dispersions in water. Top: samples under room lighting. Bottom: samples under 365 nm UV irradiation. Photos of purified PP-CDs under ambient light and under 365 nm UV irradiation are provided. The dispersion of PP-CDs-120 has a light brown appearance due to appreciable extinction at shorter visible wavelengths, while PP-CDs-150 and PP-CDs-180 are mostly colorless due to their extremely small size. There is no significant color and state change over the two-month period.

FIG. 32: Absorption spectra of PP-NPs and mixed solvents for the NIPS method.

FIG. 33: Absorption (black) and photoluminescence spectrum of dialyzed PP-CDs.

FIG. 34: FT-IR transmittance spectra of PP-CDs, graphite and PP-NPs with peak marked.

FIGS. 35A-35C: PXRD patterns of PP-CDs from different hydrothermal temperatures of 180° C. (FIG. 35A), 150° C. (FIG. 35B), and 120° C. (FIG. 35C). Insets show proposed intermolecular order of the grains within the carbon dots based on the PXRD grain size analysis.

FIGS. 36A-36B. Raman spectra of PP-CDs (FIG. 36A), and of PP-NPs, graphite and blank Si substrate (FIG. 36B)

FIGS. 37A-37C: Raman peak fitting for the three PP-CDs samples prepared at 120° C. (FIG. 37A), 150° C. (FIG. 37B), and 180° C. (FIG. 37C).

FIGS. 38A-38L: XPS Deconvolution results of C, O, N and S scans on PP-CDs. FIGS. 41A-41C: C 1s Scan of CDs from 120° C. (FIG. 38A), 150° C. (FIG. 38B) and 180° C. (FIG. 38C). FIGS. 38D-41F: O 1s Scan of CDs from 120° C. (FIG. 38D), 150° C. (FIG. 38E) and 180° C. (FIG. 38F). FIGS. 38G-38I: N 1s Scan of CDs from 120° C. (FIG. 38G), 150° C. (FIG. 38H) and 180° C. (FIG. 38I). FIGS. 38J-38L: S 2p Scan of CDs from 120° C. (FIG. 38J), 150° C. (FIG. 38K) and 180° C. (FIG. 38L).

FIG. 39: XPS spectrum of graphite powder deposited on a Si substrate.

FIGS. 40A-40D: Size distribution, absorption, and emission spectra of Carbon dots from 120 C, 14-hour reaction. FIG. 40A: Absorption spectra of CDs from PP pellets with 120° C., 14-hour reaction. Inset: Size distribution of CDs from PP pellets with 120° C., 14-hour reaction. FIG. 40B: Absorption spectra of CDs from PP waste with 120° C., 14-hour reaction. Inset: Size distribution of CDs from PP waste with 120° C., 14-hour reaction. FIG. 40C: Photoluminescence spectra of CDs from PP pellets with 120° C., 14-hour reaction. FIG. 40D: Photoluminescence spectra of CDs from waste with 120° C., 14-hour reaction.

FIGS. 41A-41E: High-resolution transmission electron microscopy (HRTEM) images of freeze-dried, redispersed in water and redried sample from 180° C. hydrothermal reaction, where FIG. 41B depicts a magnified region of the image of FIG. 41A, selected area by square. FIG. 41C depicts a first magnified region of the image of FIG. 41B, selected in the diffraction inset. FIG. 41D depicts a second magnified region of the image of FIG. 41B, inset: diffraction pattern of selected area by circle. FIG. 41E depicts a magnified region of the image of FIG. 41D.

FIG. 42: PXRD pattern of air-dried, redispersed in water and redried sample from 180° C. hydrothermal reaction. The PXRD pattern indicates that air-dried sample has a different crystalline structure from freeze-dried sample though they both were redispersed in water and redried in vacuum.

FIGS. 43A-43B: Scanning electron microscopy (SEM) images of air-dried, redispersed in water and redried sample from 180° C. hydrothermal reaction.

FIG. 44: PXRD pattern of air-dried, redispersed in ethylene glycol and redried sample from 180° C. hydrothermal reaction.

FIGS. 45A-45B: SEM images of air-dried, redispersed in ethylene glycol and redried sample from 180° C. hydrothermal reaction. The SEM images indicate that the dispersion solvent influences the morphology of products.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### DESCRIPTION

Preparation of Carbon Dots (CDs) from Plastic Waste (e.g., Polypropylene)

In one aspect, the present disclosure relates to methods of preparing carbon nanomaterials, such as carbon dots (CDs), from plastic and/or plastic waste feedstocks (e.g., polypropylene). Carbon dots (CDs) are carbon-based nanoparticles that have specific carbon core structures and functional groups that give them fluorescent properties. In certain embodiments, CDs are luminescent. CDs have applications in optoelectronics, sensors, bio-imaging, and luminescent devices such as displays.

A variety of methods exists for the synthesis of CDs, and methods of converting waste plastic into CDs are similarly described in the literature. Methods currently used to turn PP and PET into CDs include thermal calcination and hydrothermal methods. In the thermal calcination method, the plastic is heated with a limited amount of oxygen. This helps purify the different plastic waste materials in order to prepare them for further processes. In the hydrothermal method, an aqueous system is heated to high temperatures and pressurized. As pressure increases, the boiling point of water increases simultaneously, allowing the system to be heated to higher temperatures, ensuring full dissolution of the solute.

The hydrothermal method is commonly used for the conversion of plastic polymer waste into CDs. Methods reported in the literature may require high temperatures (e.g., 200° C. to 300° C.) and/or the addition of oxidative reagents (e.g., HNO₃) to facilitate CD synthesis. Hydrothermal conversion of plastic polymer materials into CDs has been reported using H₂SO₄. However, very high temperatures are often required to achieve luminescent carbon nanomaterials which can appropriately be characterized as carbon dots (i.e., <10 nm diameter). Aji, et al. (Environ. Nanotechnol. 2018, 9:136-140) have reported hydrothermal conversions requiring temperatures of 300° C. to achieve CDs having a diameter of less than 10 nm. Further, oxidative means of conversion are commonly used, including the use of dilute HNO₃ and heating. However, application of such methods result in incomplete conversion of the plastic starting material, as evidenced by Raman spectral data (i.e., signature unreacted and/or unconverted polypropylene signals observed) (Green Chem., 2023, 25:1925-1937).

Thus, in one aspect, the present disclosure relates to a method for preparing carbon nanomaterials (e.g., carbon dots) without the need for excessive temperatures, while providing carbon nanomaterials substantially free of starting material plastic polymers. In certain embodiments, the present disclosure relates to the discovery of methods utilizing an initial non-solvent induced phase separation and/or reprecipitation to obtain plastic nanoparticles from plastic materials (e.g., polypropylene waste) with a subsequent hydrothermal synthesis of carbon nanomaterials at relatively mild temperatures.

The methods further allow for a greater surface area in which the PP material could undergo carbonization, increasing its yield. As described herein, CDs were synthesized from both commercial PP pellets as well as a waste PP food container. A range of temperature and time conditions were tested for the hydrothermal method. The CDs were purified using centrifugation, syringe filtration, and/or dialysis. Characterizations of the resultant CDs were conducted using photoluminescence (PL) spectroscopy, UV-Vis absorption spectroscopy, and DLS, inter alia, thereby demonstrating the desirable properties of the thus prepared CDs and the potential of the presently described method.

Preparation of Carbon Nanomaterials and or Graphitic-like Materials from Carbon Dots (CDs)

In another aspect, the present disclosure relates to methods for preparing carbon nanomaterials, or graphitic-like materials (e.g., nanographene), from carbon dots (CDs). In certain embodiments, the disclosure describes the unexpected discovery that post-processing of the CDs prepared from plastic waste materials, as described herein, permits preparation of carbon nanomaterials or graphitic-like materials with high crystallinity. Although the present disclosure describes preparing the ordered graphitic-like materials from CDs prepared from plastic waste, the starting materials contemplated herein are not limited to CDs prepared from plastic waste.

Without wishing to be bound by any theory, it is hypothesized herein that the post-processing of the carbon dots described herein alters the properties of the CD material and causes the material to assembled into larger sized graphitic materials. Thus, in certain embodiments, the disclosure provides a potentially low-cost approach to producing advanced carbon-based materials with desirable properties, such as high conductivity, thermal stability, and mechanical strength, from a plastic waste feedstock. These materials can be used in various applications, including energy storage (e.g., supercapacitors and batteries), catalysis, electronics, and/or biomedicine.

### Definitions

The term “about” as used herein can allow for a degree of variability in a value or range, for example, within 10%, within 5%, or within 1% of a stated value or of a stated limit of a range, and includes the exact stated value or range.

The term “alcohol” as used herein is defined as any acyclic organic compound in which a hydroxyl group (—OH) is bound to a carbon atom of an alkyl or substituted alkyl group.

The term “alkyl” as used herein refers to a straight or branched chain hydrocarbon having the number of carbon atoms designated (i.e., C₁-C₁₀ means one to ten carbon atoms) and includes straight, branched chain, or cyclic substituent groups. Examples include methyl, ethyl, propyl, isopropyl, butyl, isobutyl, tert-butyl, pentyl, neopentyl, hexyl, and cyclopropylmethyl. A specific embodiment is (C₁-C₆) alkyl, such as, but not limited to, ethyl, methyl, isopropyl, isobutyl, n-pentyl, n-hexyl and cyclopropylmethyl.

The term “aromatic” as used herein refers to cyclically conjugated hydrocarbons with a stability (due to delocalization) that is significantly greater than that of a hypothetical localized structure (e.g., Kekulé structure). An “aromatic” compound can be referred to as a carbocycle or heterocycle with one or more polyunsaturated rings and having aromatic character, i.e., having (4n+2) delocalized π (pi) electrons, where ‘n’ is an integer. The most common method for determining aromaticity of a given hydrocarbon is the observation of diatropicity in the ¹H NMR spectrum, for example, the presence of chemical shifts in the range of 7.2 to 7.3 ppm for aromatic ring protons. Non-limiting exemplary “aromatic” compounds include benzene, toluene, xylenes, naphthalene, furan, pyrrole, imidazole, and pyridine.

The term “carbon dot” or “carbon quantum dot” as used herein refers to spherical or quasi-spherical, luminescent carbon nanoparticles which have some form of surface passivation. Carbon dots typically have a lateral diameter of less than about 10 nm, but may have a lateral diameter of up to about 400 nm. Carbon dots can be crystalline, polycrystalline, or amorphous in internal structure, and may comprise one or more surface functionalizations and/or dopant elements.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, wherein X¹ and X² are the same but X³ is different, and other analogous permutations.

The term “luminescent material” as used herein refers to a material that is capable of emitting electromagnetic radiation upon stimulation. In certain embodiments, a luminescent material is able to convert light of a first wavelength into a light of a second wavelength.

The term “nanoparticle” as used herein, refers to a spherical or quasi-spherical particle of less than 1,000 nm in diameter. The nanoparticle may be solid or hollow.

The terms “low polarity solvent” or “nonpolar solvent” as used herein refer to any compound, or mixture of compounds, that have a low polarity index as compared to water. Non-limiting examples of nonpolar solvents include benzene, toluene, xylenes (i.e., 1,2-dimethylbenzene, 1,3-dimethylbenzene, 1,4-dimethylbenzene, and any mixtures thereof), CHCl₃, CH₂Cl₂, Et₂O and/or aliphatic hydrocarbon solvents (e.g., hexane and pentane, inter alia).

The term “plastic” as used herein, generally refers to a polymeric material, made in whole, or part, of at least one hydrocarbon, that may contain one or more modifications and/or may be compounded with an additive (e.g., colorants, plasticizers, etc.) to form a useful material. Non-limiting examples of plastics include polypropylene (PP), polyethylene terephthalate (PET), polyamides (PA), polycarbonates (PC), polyesters (PES), polyethylene (PE), high-density polyethylene (HDPE), low-density polyethylene (LDPE), polystyrene (PS), high impact polystyrene (HIPS), polyurethanes (PU), polyvinyl chloride (PVC), polyvinylidene chloride (PVDC), acrylonitrile butadiene styrene (ABS), polyepoxides, polymethyl methylacrylate (PMMA), polytetrafluoroethylene (PTFE), phenol formaldehyde (PF), melamine formaldehyde (MF), urea-formaldehyde (UF), polyetheretherketone (PEEK), polyetherimide (PEI), polyimides, polylactic acid (PLA), furans, silicones, polysulfones, polydiketoenamine, and any combinations thereof.

The term “polar solvent” as used herein refers to any compound, or mixture of compounds, that has a high polarity index, similar to that of water, and that is miscible with the nonpolar solvent. Non-limiting examples of polar solvents include water, methanol, ethanol, propanol, acetone, ethylene glycol, and ethyl acetate.

The term “solvent” as used herein refers to a nonreactive component of a composition or reaction mixture capable of dissolving or dispersing one or more components of the composition (i.e., solutes). In certain embodiments, the “solvent” reduces the viscosity of the composition. In certain embodiments, the “solvent” has a volatility such that it is removed under the conditions (e.g., elevated temperature and/or reduced pressure).

The term “vessel” as used herein refers to a container in which reactants, solvents, catalysts, or other materials, can be mixed for a reaction. The vessel can be made from any material known to those skilled in the art, such as metal, ceramic, or glass. In certain embodiments, the vessel can be sealed. In certain embodiments, the vessel can be suitable to withstand high pressure (e.g., stainless steel pressure vessel), such as a Parr™ vessel or Teflon™-lined autoclave.

The term “waste material” as used herein, may relate to one or more byproducts resulting from at least one process and having relatively little or no substantial use or worth. The waste material may be a substance generated, for example, during an industrial process, or otherwise discarded packing, container, or instrument. In some examples, waste material may be a substance that is generally disposed, destroyed (e.g., incinerated), and/or recycled in a process associated with one entity (e.g., a waste material generator or other entity possessing the waste material) paying a fee to another entity handling the disposal, destruction, and/or recycling of the substance. Non-limiting examples of waste materials contemplated herein include packaging materials (e.g., plastic bags, food containers, and beverage bottles), consumer goods (e.g., toys and appliances), disposable medical and/or research devices (e.g., syringes and test tubes), 3D printed filaments, and furniture.

### Methods

In one aspect, the present disclosure provides a method for preparing a carbon nanomaterial. In certain embodiments, the method comprises (a) heating a first mixture comprising a plastic material and a first solvent to provide a first solution. In certain embodiments, the first solvent comprises a nonpolar or low polarity solvent. In certain embodiments, the method comprises (b) contacting the first solution with a polar solvent to provide a second mixture. In certain embodiments, the method comprises (c) isolating plastic nanoparticles from the second mixture by removing at least a portion of the solvent in the second mixture. In certain embodiments, the method comprises (d) suspending the plastic nanoparticles in an oxidizing solvent to provide a third mixture. In certain embodiments, the method comprises (e) heating the third mixture in a sealed vessel to provide a fourth mixture comprising the carbon nanomaterial. In certain embodiments, the heating of the third mixture occurs at a temperature ranging from about 100° C. to about 200° C. for a period of about 1 h to about 24 h. In certain embodiments, the heating of the third mixture occurs at a temperature of about 100° C. to about 200° C. for a period of about 14 h to about 24 h.

In certain embodiments, the plastic material comprises polypropylene (PP). In certain embodiments, the plastic material comprises polyethylene terephthalate (PET). In certain embodiments, the plastic material comprises polyethylene (PE). In certain embodiments, the plastic material comprises polyurethane (PU). In certain embodiments, the plastic material comprises polystyrene (PS).

In certain embodiments, the plastic material is a waste material. In certain embodiments, the waste material is waste derived from packaging (e.g., containers and/or bags). In certain embodiments, the waste material is waste derived from consumer goods (e.g., toys and/or appliances). In certain embodiments, the waste material is waste derived from industrial processes.

In certain embodiments, the first solvent consists essentially of the nonpolar or low polarity solvent. In certain embodiments, the first solvent consists of at least one nonpolar or low polarity solvent.

In certain embodiments, the nonpolar or low polarity solvent is at least one selected from the group consisting of toluene, benzene, 1,2-dimethylbenzene, 1,3-dimethylbenzene, and 1,4-dimethylbenzene.

In certain embodiments, the nonpolar or low polarity solvent is toluene. In certain embodiments, the nonpolar or low polarity solvent is benzene. In certain embodiments, the nonpolar or low polarity solvent is 1,2-dimethylbenzene. In certain embodiments, the nonpolar or low polarity solvent is 1,3-dimethylbenzene. In certain embodiments, the nonpolar or low polarity solvent is 1,4-dimethylbenzene.

In certain embodiments, the heating of the first mixture occurs at a temperature of about 75, 80, 85, 90, 95, 100, 105, 110, 115, 120, 125, 130, 135, 140, or about 145° C. In certain embodiments, the nonpolar or low polarity solvent is toluene and the heating occurs at a temperature of about 110° C.

In certain embodiments, the first solution has a total dissolved and/or suspended concentration of plastic material of about 1, 2, 3, 4, 5, 6, 7, 8, 9, 10, 11, 12, 13, 14, 15, 16, 17, 18, 19, 20, 21, 22, 23, 24, or about 25 mg/mL. In certain embodiments, the first solution has a dissolved or suspended concentration of plastic material of about 6.5 mg/mL.

In certain embodiments, the polar solvent is an alcohol. In certain embodiments, the alcohol is ethanol.

In certain embodiments, the polar solvent and first solution have a volume ratio of about 1:1, 1:2, 1:3, 1:4, 1:5, 1:6, 1:7, 1:8, 1:9, or about 10:1. In certain embodiments, the polar solvent and first solution have a ratio of about 5:1.

In certain embodiments, the second mixture is agitated. In certain embodiments, the agitation comprises stirring. In certain embodiments, the agitation occurs at room temperature.

In certain embodiments, the step of removing at least a portion of the solvent in the second mixture comprises evaporation at reduced pressure. In certain embodiments, the step of removing at least a portion of the solvent in the second mixture comprises filtration. In certain embodiments, the step of removing at least a portion of the solvent in the second mixture comprises centrifugation.

In certain embodiments, the evaporation at reduced pressure occurs by rotary evaporation (i.e., reduced pressure of about 20 mbar to about 200 mbar). In certain embodiments, the evaporation at reduced pressure further comprises exposure to high vacuum (i.e., reduced pressure of about 10⁻³ mbar to about 10⁻⁷ mbar).

In certain embodiments, the oxidizing solvent is H₂SO₄. In certain embodiments, the H₂SO₄ is concentrated H₂SO₄. In certain embodiments, the oxidizing solvent is HNO₃. In certain embodiments, the HNO₃ is concentrated HNO₃ (fuming). In certain embodiments, the oxidizing solvent is H₃PO₄. In certain embodiments, the H₃PO₄ is concentrated H₃PO₄. In certain embodiments, the oxidizing solvent is HCl. In certain embodiments, the HCl is concentrated HCl.

In certain embodiments, the heating of the third mixture comprises heating at a temperature of about 120° C. for a period of about 6 h. In certain embodiments, the heating of the third mixture comprises heating at a temperature of about 120° C. for a period of about 14 h. In certain embodiments, the heating of the third mixture comprises heating at a temperature of about 150° C. for a period of about 6 h. In certain embodiments, the heating of the third mixture comprises heating at a temperature of about 150° C. for a period of about 14 h. In certain embodiments, the heating of the third mixture comprises heating at a temperature of about 180° C. for a period of about 6 h. In certain embodiments, the heating of the third mixture comprises heating at a temperature of about 180° C. for a period of about 14 h.

In certain embodiments, the method further comprises purification of the carbon nanomaterial. In certain embodiments, the isolation of the carbon nanomaterial comprises diluting the fourth mixture with water to provide a fifth mixture. In certain embodiments, the isolation of the carbon nanomaterial comprises centrifuging the fifth mixture to provide a supernatant. In certain embodiments, the isolation of the carbon nanomaterial comprises filtering the supernatant using a filter having a pore size of less than about 1.0 μm to provide a filtrate. In certain embodiments, the isolation of the carbon nanomaterial comprises subjecting the filtrate to dialysis.

In certain embodiments, the method further comprises a post-processing the carbon nanomaterial.

In certain embodiments, the post-processing comprises subjecting the isolated carbon nanomaterial to a first drying process to provide a dried carbon nanomaterial. In certain embodiments, the post-processing comprises redispersing the dried carbon nanomaterial in a suitable solvent to provide a redispersed carbon nanomaterial. In certain embodiments, the post-processing comprises subjecting the redispersed carbon nanomaterial to a second drying step.

In certain embodiments, the first drying step comprises a freeze drying process. In certain embodiments, the first drying step comprises an air drying process. In certain embodiments, the first drying step comprises a heat drying process. In certain embodiments, the first drying step comprises a vacuum drying process.

In certain embodiments, the suitable solvent comprises water. In certain embodiments, the suitable solvent comprises ethylene glycol. In certain embodiments, the suitable solvent comprises water and ethylene glycol. In certain embodiments, the redispersed carbon nanomaterial has a concentration of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 mg/mL. In certain embodiments, the redispersed carbon nanomaterial has a concentration of less than 1 mg/mL. In certain embodiments, the redispersed carbon nanomaterial has a concentration greater than 50 mg/mL.

In certain embodiments, the second drying step comprises distributing the redispersed carbon nanomaterial as a film on a substrate surface to provide a distributed redispersed carbon nanomaterial. In certain embodiments, the second drying step comprises removing any solvent by heating the distributed redispersed carbon nanomaterial. In certain embodiments, the second drying step comprises removing any solvent by exposing the distributed redispersed carbon nanomaterial to vacuum. In certain embodiments, the second drying step comprises removing any solvent by exposing the distributed redispersed carbon nanomaterial to air. In certain embodiments, the substrate comprises silicon. In certain embodiments, the substrate comprises carbon tape.

In certain embodiments, the carbon nanomaterial comprises a carbon dot.

In certain embodiments, the carbon dot has a diameter of about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or about 10.0 nm. In certain embodiments, the carbon dot has a diameter of about 1, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or about 400 nm.

In certain embodiments, the carbon dot has a diameter greater than about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or about 10.0 nm. In certain embodiments, the carbon dot has a diameter of greater than about 1, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or about 400 nm.

In certain embodiments, the carbon dot has a diameter less than about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or about 10.0 nm. In certain embodiments, the carbon dot has a diameter of less than about 1, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or about 400 nm.

In certain embodiments, the carbon dot has a diameter ranging from about 1 nm to about 360 nm. In certain embodiments, the carbon dot has a diameter ranging from about 1.5 nm to about 5.3 nm.

In certain embodiments, the carbon dot is at least partially doped with oxygen, sulfur, and/or nitrogen.

In certain embodiments, the carbon dot is substantially free of the plastic material.

In another aspect, the disclosure provides a method for altering the morphology of carbon nanomaterials. In certain embodiments, the carbon nanomaterial is a carbon dot. In certain embodiments, the method provides a graphitic-like carbon nanomaterial. In certain embodiments, the graphitic-like carbon nanomaterial comprises a large, highly ordered, and/or layered carbon nanomaterial (e.g., graphene).

In certain embodiments, the method comprises subjecting an carbon nanomaterial to a first drying process to provide a dried carbon nanomaterial. In certain embodiments, the method comprises redispersing the dried carbon nanomaterial in a suitable solvent to provide a redispersed carbon nanomaterial. In certain embodiments, the post-processing comprises subjecting the redispersed carbon nanomaterial to a second drying step.

In certain embodiments, the first drying step comprises a freeze drying process. In certain embodiments, the first drying step comprises an air drying process. In certain embodiments, the first drying step comprises a heat drying process. In certain embodiments, the first drying step comprises a vacuum drying process.

In certain embodiments, the suitable solvent comprises water. In certain embodiments, the suitable solvent comprises ethylene glycol. In certain embodiments, the suitable solvent comprises water and ethylene glycol. In certain embodiments, the redispersed carbon nanomaterial has a concentration of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 mg/mL. In certain embodiments, the redispersed carbon nanomaterial has a concentration of less than 1 mg/mL. In certain embodiments, the redispersed carbon nanomaterial has a concentration greater than 50 mg/mL.

In certain embodiments, the second drying step comprises distributing the redispersed carbon nanomaterial as a film on a substrate surface to provide a distributed redispersed carbon nanomaterial. In certain embodiments, the second drying step comprises removing any solvent by heating the distributed redispersed carbon nanomaterial. In certain embodiments, the second drying step comprises removing any solvent by exposing the distributed redispersed carbon nanomaterial to vacuum. In certain embodiments, the second drying step comprises removing any solvent by exposing the distributed redispersed carbon nanomaterial to air. In certain embodiments, the substrate comprises silicon. In certain embodiments, the substrate comprises carbon tape.

In certain embodiments, the graphitic-like carbon nanomaterial is graphene. In certain embodiments, the graphene is layered. In certain embodiments, the graphene comprises a carbon nanotube. In certain embodiments, the carbon nanotube is a single-walled carbon nanotube. In certain embodiments, the carbon nanotube is a multi-walled carbon nanotube. In certain embodiments, the graphene is holey graphene.

In another aspect, the present disclosure provides a carbon nanomaterial prepared according to the methods of the present disclosure.

### Examples

Various embodiments of the present application can be better understood by reference to the following Examples which are offered by way of illustration. The scope of the present application is not limited to the Examples given herein.

### Materials and Methods

### General

PP pellets were obtained from a commercial source and PP waste was obtained from a 32 oz PP food container. Toluene (C₆H₅CH₃) and ethanol (CH₃CH₂OH) were used as the solvent pair for the NIPS method. Concentration sulfuric acid (H₂SO₄) was used to dissolve and carbonize the PP. Teflon-lined autoclaves were used when conducting the hydrothermal reaction due to their high heat resistance and corrosion resistance to acids and bases. A Thermo-Fisher Scientific Lindberg Blue M oven was used to heat the autoclaves. An Ocean Optics FHSA-TTL UV-Vis spectrometer was used to measure the absorption of the CDs. A Horiba Jobin Yvon Symphony-Solo PL spectrophotometer was used with Horiba's FluorEssence software in order to measure and graph the PL of the CDs. A Thermo Fisher Scientific centrifuge was used to separate the CDs from unreacted particles suspended in the sulfuric acid and water solution. Syringe filters (Biomed Scientific) with a pore size of 0.45 μm were used to filter the CDs after centrifugation. 3.5 kDa dialysis film was used to purify the resultant CDs. A Malvern Panalytical Zetasizer DLS instrument, and accompanying software, were used to automatically analyze the purified samples to determine the particle sizes in the solutions.

### Carbon Dot (CD) Synthesis

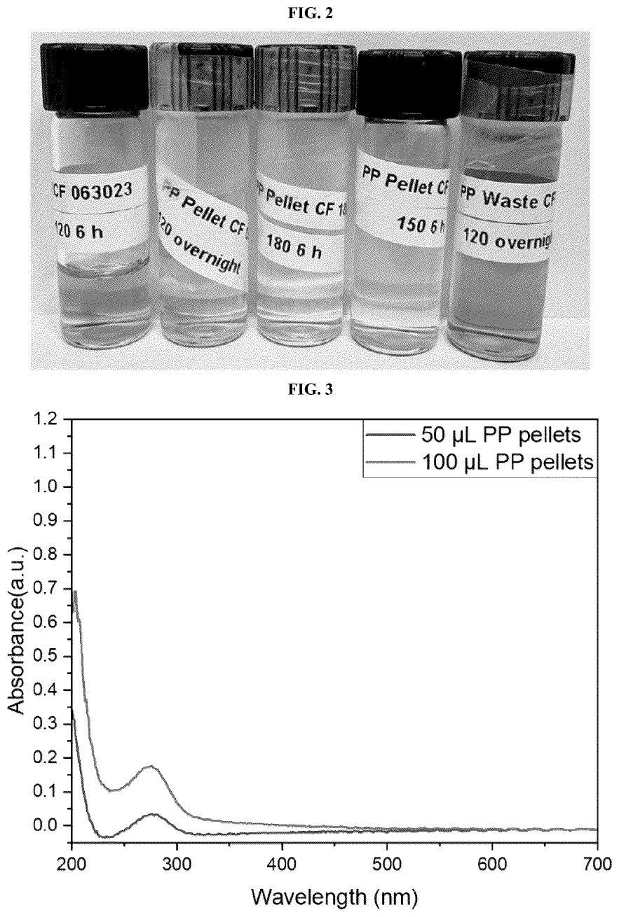

To synthesize the CDs, a two-step process was used. First, the NIPS method was used to pre-process the PP pellets and waste into smaller nanoparticles, which provides greater surface area for carbonization. Then, the hydrothermal method was used to synthesize the CDs. For the NIPS method, 26 mg of PP and 4 mL of toluene, a non-polar solvent, were placed into a 50 mL round-bottom flask. A reflux apparatus was set up above the flask to minimize evaporation of the toluene via cooling and condensing of the vapor. The apparatus was then heated in a bath of silicon oil on a 260° C. hot plate. Once the silicon oil reached a temperature of 110° C., the temperature of the hot plate was dynamically lowered to ensure a constant solution temperature of 110° C. The solution was then stirred at 100 rpm for 30 minutes until the PP pellets dissolved. After that, 20 mL of ethanol, a polar solvent, was added to the flask. The solution was stirred for 3 hours at 300 rpm without applying heat. A rotary evaporator was used to remove the solvents, followed by a 10-minute high-vacuum drying process, leaving dry PP nanoparticles in the flask. Then, 10 mL of sulfuric acid was added and the solution was transferred to a Teflon-lined autoclave and heated in a ThermoFisher oven. Five separate conditions with varied temperatures, autoclaving time, and starting material were tested as shown in FIG. 2. Once the hydrothermal reaction was completed, the PP solution was diluted with deionized (DI) water at a volume ratio of 1:5 raw product to water. The resultant solution was then pipetted into 2 mL centrifuge tubes. Each pair of centrifuge tubes was balanced with a mass difference within 0.5 mg. The centrifuge was then spun at 13,300 rpm for 30 minutes. A pipette was used to transfer the supernatant from the centrifuge tubes to a set of new vials. Then, using a syringe, the CDs were pushed through a filter with a 0.45 μm pore size to remove the unreacted residues and large particles.

### Purification of Polypropylene Carbon Dots

The raw product was diluted with distilled water in a 1:5 ratio. After that, the solution was centrifuged (Fisher Scientific AccuSpin Micro 17 centrifuge) for 30 minutes at 17,000 g to remove unreacted polypropylene nano plastic residues and supernatant was collected, which was further filtered with a 0.45 μm membrane filter to get rid of the large carbon particles. For PXRD and FT-IR experiments, a further dialysis procedure was performed with a regenerated cellulose dialysis membrane having a molecular weight cutoff of 3.5 kDa (Repligen Corporation, manufacturer part number: 132725T) to remove sulfate ions to get a lyophilized powder sample. BaCl₂ and HCl were used to detect the sulfate ion during the dialysis process.

### UV-Visible Spectroscopy

In order to characterize the resultant CDs, UV-Vis absorption spectroscopy was used to analyze samples. After the CD solution was purified in the centrifuge, 50 μL of the solution was diluted in 2 mL of DI water in a quartz cuvette. The cuvette was then placed in the UV-Vis spectrometer where absorbance data was collected at excitation wavelengths ranging from 200 nm to 930 nm. Following the characterization of 50 μL of the solution, another 50 μL was added into the cuvette and analyzed again in order to gain data on 100 μL of the solution. The collected data was then imported into Excel for processing in order to calibrate for the large jump in absorbance at 460 nm. This is a result of the switch from the ultraviolet light-producing Deuterium lamp to the visible light-producing Tungsten lamp during the spectroscopy process. First, the difference between the absorbance at 460 nm and 459 nm was calculated. This value was then subtracted from the absorbance at every wavelength of 460 nm and greater to account for the difference between the two lamps. Finally, this processed data was imported into OriginPro for plotting and scaled to only display wavelengths from 200 nm to 700 nm.

### Photoluminescence Spectroscopy

In order to characterize the photoluminescent properties of the synthesized CDs, photoluminescence spectroscopy was used. First, 2.8 mL of DI water was poured into a quartz cuvette and analyzed using a PL spectrophotometer from excitation wavelengths of 300 nm to 550 nm, and measured emission wavelengths from 315-700 nm. Once the water reference data was collected, the various CD samples were measured. First, 2 mL of DI water was mixed with 0.8 mL of each sample solution in a quartz cuvette. Next, this cuvette was placed into the PL spectrophotometer and its PL spectra were measured at excitation wavelengths of 300 nm to 550 nm in alternating intervals of 30 nm and 20 nm (300 nm, 330 nm, 350 nm, etc.). For each trial, the emission wavelength was measured from 15 nm greater than the excitation wavelength to 10 nm less than double the excitation wavelength or 700 nm, whichever was the least (300 nm excitation was measured at the emission of 315 nm to 590 nm). Then, the PL spectra of the water reference were subtracted from the PL spectra of the CDs to account for the DI water in the CD solutions. After the collection of all the data using the PL spectrometer, a custom Python script was written to subtract the PL emission peak of the water reference from the PL data of each of the five sample solutions. The Python script interfaces directly with ASCII data files from the Horiba FluorEssence software and with Excel files. Using the custom Python script, efficiency was increased and less time was needed to manually subtract the water reference spectra from each solution's spectra. Finally, the data with subtracted water reference in Excel was imported into Origin Pro and graphed.

### Dynamic Light Scattering

Each of the five samples was diluted with DI water and passed through a syringe filter. This process separated the unwanted aggregates through filtration. The purified solution is run through a DLS instrument and the accompanying software to automatically determine the size of the particles.

### Optical Microscopy

A Zeiss Axiovert A1 microscope was used to observe two CD samples, those derived from PP pellets and heated at 180° C. for 6 hours, and those derived from PP waste and heated at 120° C. for 14 hours. Prior to microscopy, the glass slides underwent a cleaning process in the sonication and were kept in DI water before spin coating. They were then dried with pressurized air before the CDs were spin-coated on with the Laurell Technologies WS-400-6NPPLITE Spin Processor. These glass samples were prepared both statically, in which CDs were dropped before spinning began, and dynamically, in which CDs were dropped after spinning began. The CD solutions were then sealed onto the slides using epoxy and cover slides. Finally, the glass samples were observed under the microscope, both using the dark field technique and under a 470 nm laser to test for fluorescence.

### Morphology Characterization

The morphology information before and after the hydrothermal reaction was studied with a Zeiss Sigma Field Emission SEM at an accelerating voltage of 5 kV. For the SEM sample preparation, 30 μL of either PP NPs or PP-CDs was drop-cast on a copper tape, which was fixed on a double-side carbon tape. The stud was kept in vacuum at room temperature overnight. Before the characterization, a layer of 5 nm Au/Pd layer was deposited to enhance the contrast. TEM images were achieved with a Philips CM12 electron microscope with AMT-XR11 digital camera at an acerating voltage at 80 kV. 30 μL of either PP NPs or PP-CDs was drop-cast on a TEM grid and filter paper was used to remove the excess solutions. The grid was kept under 40° C. at vacuum overnight before the imaging.

### Chemical Composition Characterization

FT-IR spectroscopy was carried out using a Bruker Tensor 37 spectrometer to study the surface groups of the resulting carbon dots. The dialyzed samples were drop-cast 3-5 times on a ZnSe substrate to ensure a good signal-to-noise ratio. For XPS, dialyzed PP-CDs samples were drop-cast on a Si substrate. Graphite and PP-NPs samples on Si were also prepared for comparison. Spectra were collected with a Thermo Scientific K-Alpha X-ray photoelectron spectrometer using aluminum k-alpha radiation. The XPS data background is subtracted with Shirley method and deconvoluted with Voigt model for C, O, N and S. Raman experiments were performed on samples that were prepared in the same way as for the XPS samples. The spectra were collected with a Horiba LabRAM HR Evolution confocal Raman microscope, using a 600 groove/mm grating, 50× objective and a 532 nm excitation laser. All Raman spectra were analyzed with custom MATLAB code, which included an adaptive, iteratively reweighted Penalized Least Squares algorithm for baseline correction. Raman sub bands were peak fitted using the default nonlinear least squares method from the MATLAB curve fitting toolbox using a five Gaussian model. The powder X-ray diffraction (PXRD) experiment was performed on a Bruker D2 instrument with a 20 from 5° to 60°, with a step size of 0.02°, and accumulation time for 4 s per step. Certain Raman spectroscopy measurements were carried out with a Renishaw In Via Reflex Confocal Raman Microscope at both 532 nm and 830 nm lasers.

### Example 1: UV-Visible Absorption Spectroscopy of Exemplary Carbon Dot (CD) Samples

Three different figures were generated comparing different samples. In general, all the samples exhibit strong absorbance from 200 nm to 240 nm, which could be attributed to the n to π* transition present in the surface groups of the CDs. Additionally, the common absorption peak at approximately 275 nm could be attributed to the π to π* transition present in the carbon core of the produced CDs.

FIG. 3 compares the effect CD concentration has on absorbance by plotting 50 μL and 100 μL of the solution autoclaved at 120° C. for 14 hours. Both concentrations display troughs at approximately 240 nm and peaks at 275 nm, and the absorbance of the 100 μL solution appears to be approximately double that of the 50 μL solution. At 276.3 nm of excitation, the peak absorption of 50 μL was 0.03 a.u., while at the same wavelength for 100 μL, the peak absorption was 0.17 a.u. The negative absorbance values observed in FIG. 3, are likely attributable to calibration error.

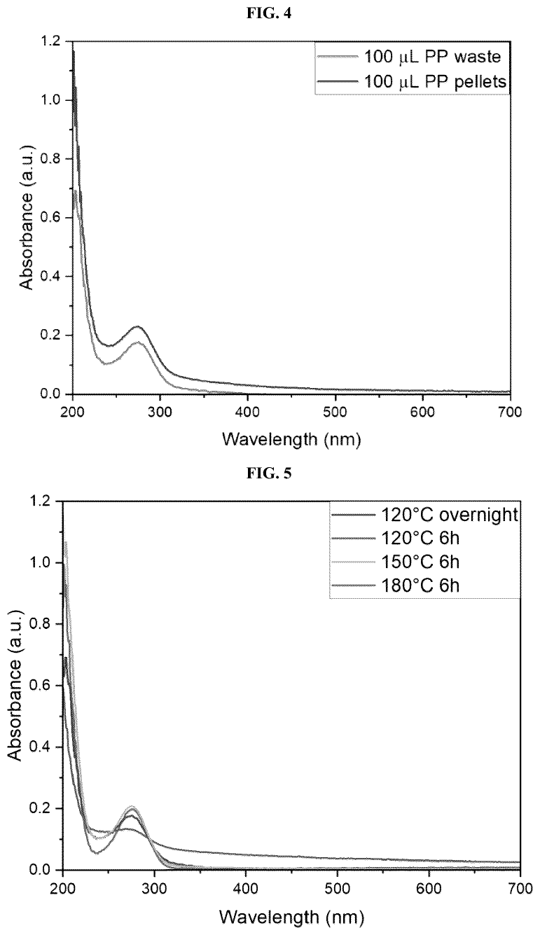

FIG. 4 compares UV-Vis spectroscopy data of PP CDs derived from virgin pellets and PP CDs derived from plastic waste. Both samples have the same volume of solution (100 μL) and are tested under the same conditions (heated in the autoclave at 120° C. for 14 hours). Similar to the data from FIG. 3, both samples exhibit troughs and peaks at 240 nm and 700 nm, as well as strong absorption from 200 nm to 400 nm. However, the two samples have a slight difference in absorbance, as the pellets have an absorbance of 0.23 a.u. at an excitation wavelength of 275.2 nm, while the waste had an absorbance of 0.18 a.u. This difference may also be attributed to a difference in the initial mass of PP matter converted into CDs. 26.3 mg of PP waste was used in comparison to 25.3 mg of PP pellets, hence the PP waste may have a higher concentration and thus a higher absorbance. FIG. 4 further shows that CDs derived from both PP waste and PP pellets have very similar absorption spectra, with the waste-derived CDs displaying a slightly greater absorbance than their pellet-derived counterparts. This clearly shows that the combination of the NIPS and hydrothermal methods used to convert PP to CDs can successfully be used to derive CDs from waste plastic, with absorption properties similar to those derived from virgin PP pellets.

FIG. 5, generated from data collected with the UV-Vis spectrometer, compared 100 μL of each of the experimental methods tested on the PP pellets (120° C. 14 h, 120° C. 6 h, 150° C. 6 h, 180° C. 6 h). All evaluated samples show absorbance peaks and troughs at similar excitation wavelengths, approximately 240 nm and 270 nm respectively. The 150° C. sample has the highest peak, closely followed by the 180° C. sample, and then the 120° C. for 14 hour and 6 hour samples. Conversely, the 180° C. sample has the lowest absorbance trough, followed by 120° C. overnight, 150° C., and finally the 120° C. for 6 hour. While the 150° C. for 6 hours, 180° C. for 6 hours, and 120° C. for 14 hours trials have a strong absorbance range from 200 nm to 350 nm, the 120° C. 6 hours sample shows strong absorbance up to the longest wavelength plotted (i.e., 700 nm). These three samples further exhibit relatively similar absorbance values, while the 120° C. 6 hour sample varies greatly.

Finally, the direct comparison of the various experimental conditions in FIG. 5 has implications for the most effective of producing CDs. Although the 150° C. for 6 hours sample shows the highest peak absorbance out of the compared methods, overall the 180° C. for 6 hours and 120° C. for 14 hours samples have relatively similar results, indicating the effectiveness of each method in producing CDs. In contrast, the 120° C. for 6 hours sample seems to be an outlier, with less extreme peaks and troughs, as well as strong absorbance for a far wider range of wavelengths than the other three samples. This is clearly seen at 350 nm, where the 120° C. for 6 hours sample still has an absorbance of approximately 0.1 a.u. while the rest of the trials were effectively at 0 a.u.

These data suggest that using the hydrothermal method at 120° C. for 6 hours for PP is not optimal for preparing pure CDs. The long tail of the 120° C. for 6 hours samples suggests the presence of a variety of particles and fluorophores present in the solution that were not eliminated during autoclaving. In contrast, at both higher temperatures (i.e., 150° C. and 180° C.), as well as at longer time periods (i.e., 14 hours), none of the samples displayed the same characteristics as the 120° C. 6 hours samples.

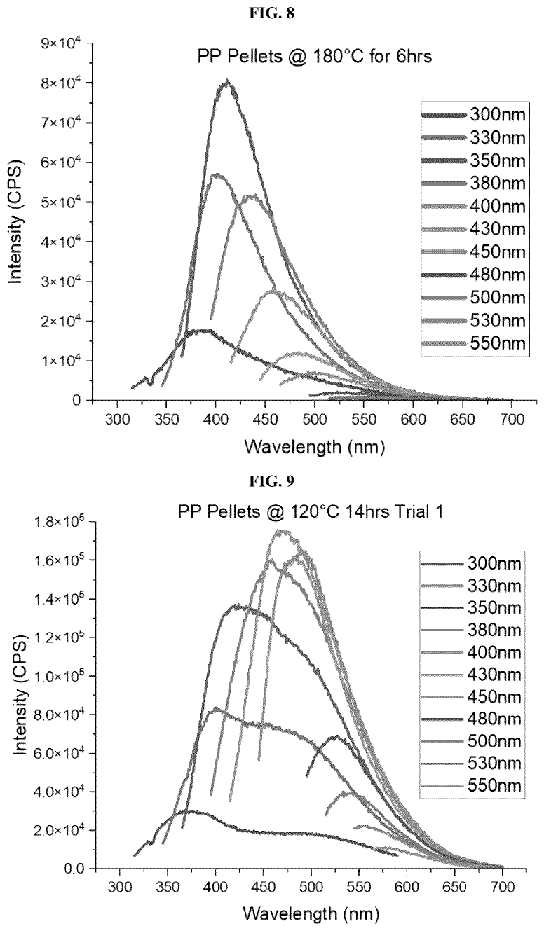

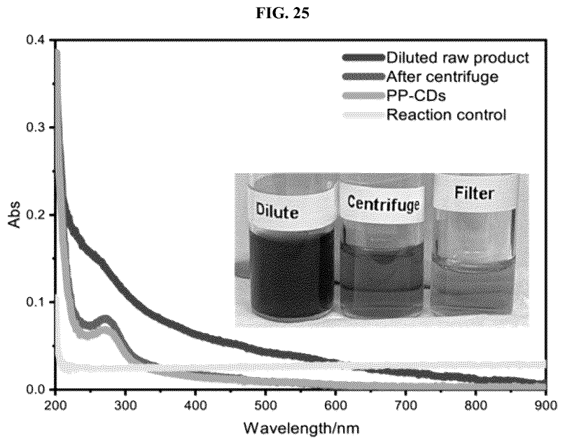

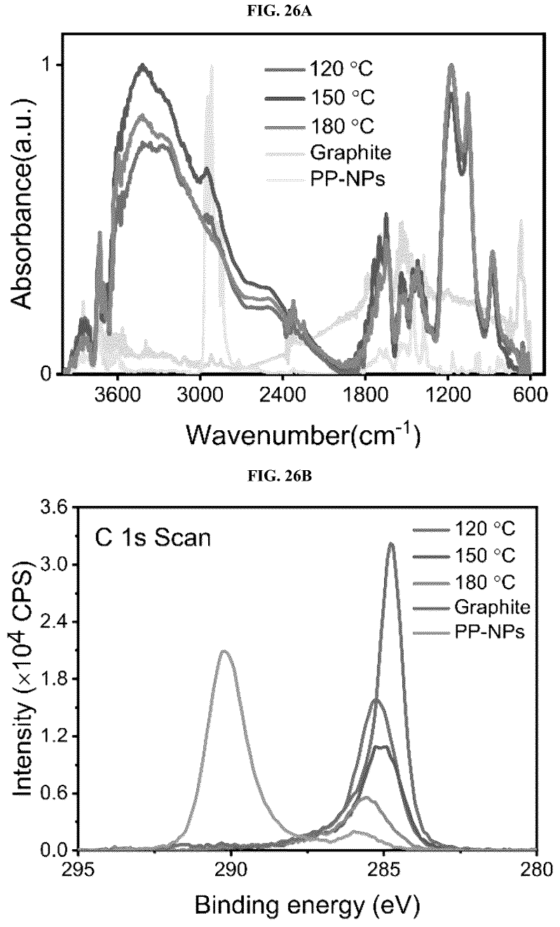

Apart from the size and morphology investigation, both UV-visible absorption spectroscopy and photoluminescence spectroscopy were performed to investigate the optical properties of the resulting PP-CDs. For the reaction control, where the process was initiated with only sulfuric acid, that is, no PP-NPs were added for the hydrothermal reaction, no absorption was observed in the spectrum and no luminescence was observed under UV light excitation (FIG. 25). This confirms the absence of undesirable side reactions or decomposition of H₂SO₄ in the reaction vessel. The UV-visible absorption spectrum of PP-NPs was also measured in DI water, as well as the mixed solvents (1/5 v/v % toluene/ethanol) as a comparison (FIG. 8). Only absorption peaks associated with ethanol and toluene were seen in the spectra and no obvious absorption of PP-NPs was observed. The diluted raw product from 120° C. has strong absorption starting at 200 nm, and slowly decays with increasing wavelength. By centrifugation, the large particle residues are removed, and this results in a distinguished absorption peak centering ˜275 nm (FIG. 25). With further filtration, it is noted that the solution becomes clearer, and the color becomes lighter, accompanied by a slight decrease in the absorbance. For the purified product, PP-CDs-120 start absorbing from 200 nm and exhibit an absorption peak between 230 nm and 300 nm, after which the absorption decays gradually. Compared to products from higher temperatures, PP-CDs-120 exhibits a lower absorbance at the peak ˜ 275 nm, as well as a long absorption tail up to 500 nm (FIG. 5), attributed primarily to light scattering.

### Example 2: Photoluminescence Spectroscopy (PL) of Exemplary Carbon Dot (CD) Samples

PL spectroscopy was used to characterize all five samples synthesized under various reaction conditions. PL curves are excitation-independent when multiple curves peak at the same emission wavelength with varying excitation wavelengths. Curves are excitation-dependent when they peak at different emission wavelengths as the excitation wavelength changes. Purer CDs display more excitation-dependent curves indicating fewer unwanted fluorophores, while less pure CDs display more excitation-independent curves.

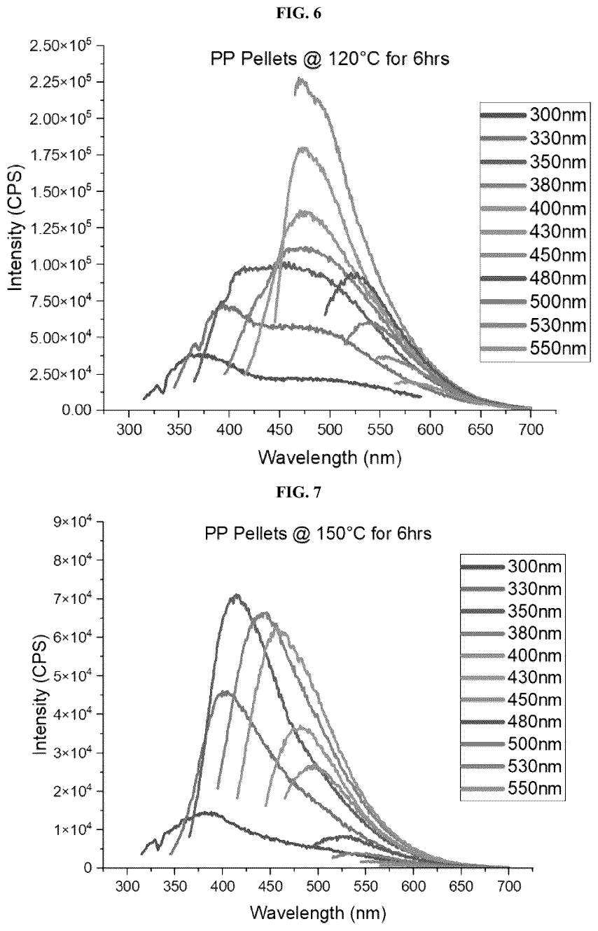

Excitation dependency and independency were analyzed for each PL graph to estimate the purity of the produced CDs. The PL data shows that higher temperatures achieved a purer product when comparing FIG. 6, FIG. 7, and FIG. 8, which show the PL spectra for PP pellets heated at 120° C., 150° C., and 180° C. for 6 hours, respectively. FIG. 6 (120° C.) displays a strong excitation-independent trend, as a peak intensity is evident at an emission wavelength of approximately 480 nm at every excitation wavelength. In contrast, FIG. 7 (150° C.), displays an excitation-dependent trend as each excitation wavelength results in an intensity peak at a different emission wavelength. Finally, FIG. 8 (180° C.) displays a strong excitation-dependent trend at higher peak intensities than FIG. 7. This observed trend in the three graphs suggests that higher autoclaving temperatures are able to produce purer CD solutions with less unreacted materials, as the excitation-independent trend is likely caused by fluorophores other than the CDs.

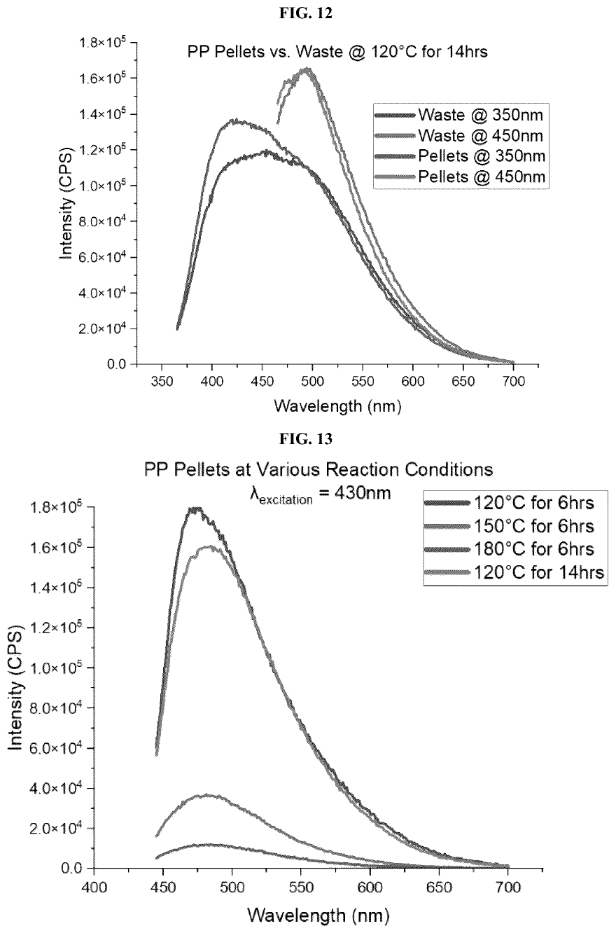

PP pellet and PP waste-derived CDs were also compared using PL spectroscopy. FIG. 9 (i.e., PP pellets heated at 120° C. for 14 hours) and FIG. 11 (i.e., PP waste heated at 120° C. for 14 hours), both of which were measured immediately following filtering, show the similarities between CDs synthesized from PP waste and those synthesized from PP pellets. The two graphs are very similar as both are excitation-dependent, have intensity peaks at an excitation wavelength of 450 nm and 480 nm, and intensity peaks at an emission wavelength of 500 nm and 475 nm, respectively. The peak emission intensity of both graphs is observed to be very similar, with the waste CDs peaking at 1.65×10⁵ CPS and the pellet CDs peaking at 1.75×10⁵ CPS. All of these similarities suggest that CDs synthesized from waste have similar characteristics to CDs synthesized from virgin PP pellet material.

This represents a promising step in the development of practical methods for converting waste PP to CDs. When considering FIG. 12, which plots the PL spectra of the CDs derived from PP pellets versus PP waste heated at 120° C. for 14 hours at excitation wavelengths of 350 nm and 450 nm, it is evident that the two samples are similar with respect to luminescence. FIG. 12 compares the relative reaction yields of CDs from PP pellets or PP waste through PL intensity by comparing the relative purity of each sample. The relative reaction yields of both are similar with little discernible difference. This result suggests that the reaction method described herein, employing the NIPS and hydrothermal methods, can be used successfully to create CDs from PP waste with very similar characteristics to those derived from virgin PP pellets.

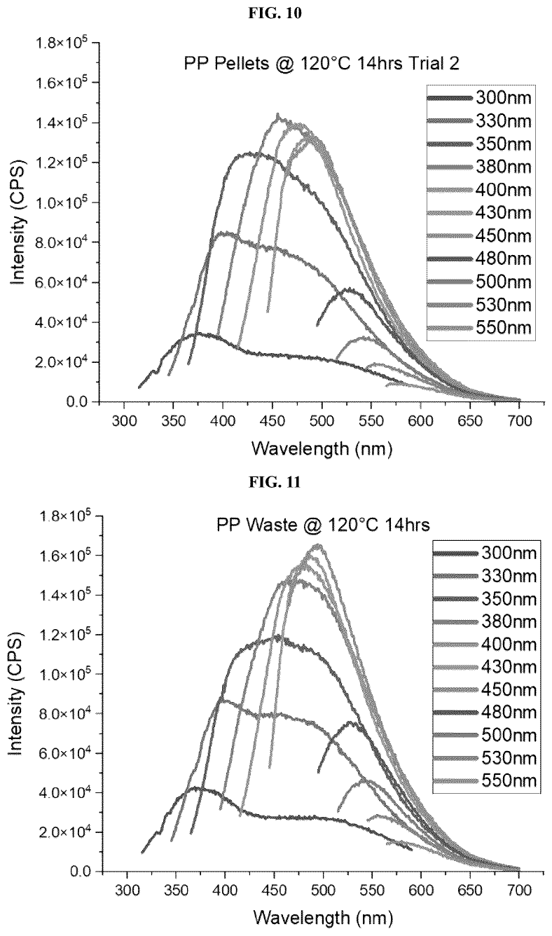

Finally, the PL emission of PP pellet derived CDs autoclaved at 120° C. for 14 hours was measured immediately following filtering and 48 hours after filtering in FIG. 9 and FIG. 10. FIG. 9 shows the PL spectra immediately after filtering, and FIG. 10 shows the PL spectra 48 hours after filtering. The CDs measured 48 hours following filtering reached a peak intensity that was approximately 12% lower than their peak intensity measured immediately following filtering. This shows that CDs derived from PP pellets at 120° C. for 14 hours may be unstable. The CDs measured immediately following filtering showed a PL intensity peak at an excitation wavelength of 450 nm and emission of 500 nm, while 48 hours later the same CDs showed a PL intensity peak at an excitation wavelength of 380 nm and emission of 450 nm. A change in the excitation wavelength required to produce the peak intensity was observed, as well as a change in the emission wavelength of the peak. Without wishing to be bound by any theory, it is hypothesized that this may be due to the aggregation of the CDs. Changes in the optical properties of the CDs after time suggest further research is required to better understand CD degradation.

The luminescence feature of PP-CDs-120 is different from the other two as it exhibits two emissive peaks with several excitation wavelengths ranging from 300 nm to 550 nm, one excitation-dependent peak and another excitation-independent peak around 470 nm (FIG. 6). However, the emission characteristics of PP-CDs-150 and PP-CDs-180 are similar to each other, where only an excitation-dependent emission peak is observed. Previous literature indicates that excitation-dependent emission is typically caused by surface group of carbon dots.

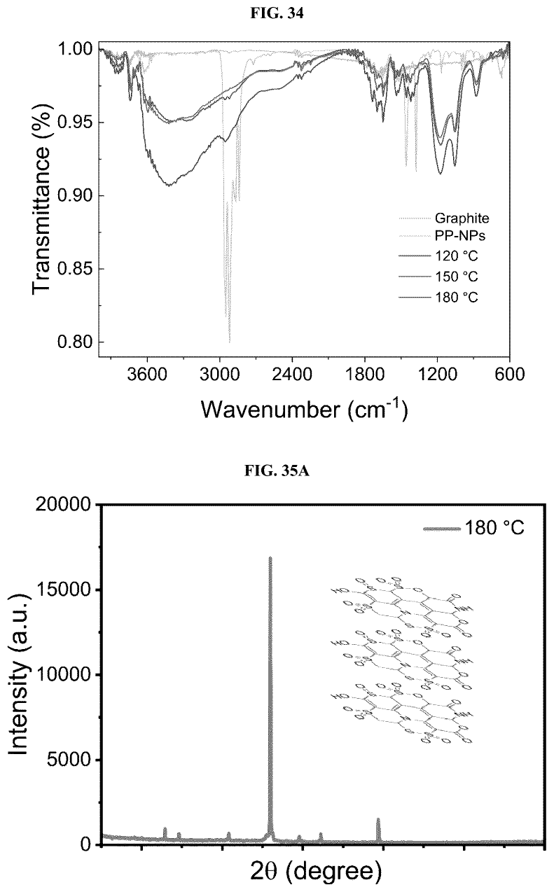

A further dialysis step was carried out to enable investigation the excitation-independent peak by removal of small molecule fluorophores. As shown in FIG. 34, after the dialysis purification, the PP-CDs-120 exhibits excitation-dependent emission only, and the pattern is similar to that of PP-CDs-150, and PP-CDs-180. This supports the assignment that the excitation-independent peak is caused by fluorophores in the synthesis as a by-product or intermediate, which is common in other CDs syntheses. In this synthesis, it was observed that the excitation-independent emission disappears with increased temperature, which may be explained by a higher transformation yield since this peak is due to the fluorophores in the system as an intermediate of the reaction.

PL quantum yield (QY) was also measured for PP-CDs. QY under 350 nm and 450 nm excitation were both acquired for PP-CDs-120, while only QY under 350 nm excitation was acquired for PP-CDs-150 and PP-CDs-180 based on the PL spectra. As shown in Table 1, PP-CDs-180 has the highest QY value of 10.3%, while the PP-CDs-120 has the lowest one, 0.2% under 350 nm excitation and 3.0% under 450 nm excitation. Given that the PP-CDs are smaller and there are few or no fluorescent reaction intermediates, the increase in quantum yield with temperature suggests the emission is enhanced by the presence of particles either due to improved activation of surface functional groups or quantum effects associated with the small particle size (˜2.5 nm for PP-CDs-180).

TABLE 1
Quantum yield results for PP-derived CDs

| Samples | PP-CDs-120 | PP-CDs-150 | PP-CDs-180 |
|---|---|---|---|
| λ_{Excitation}(nm) | 350 | 450 | 350 |
| QY/% | 0.2 | 3.0 | 4.2 |
| Absorbance | 0.09 | 0.04 | 0.06 |

### Example 3: Dynamic Light Scattering of Exemplary Carbon Dot (CD) Samples

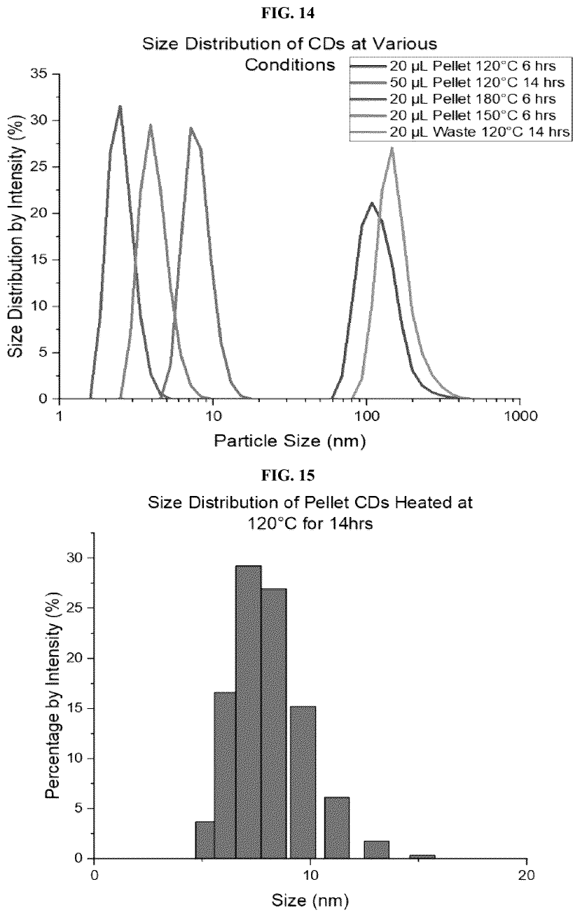

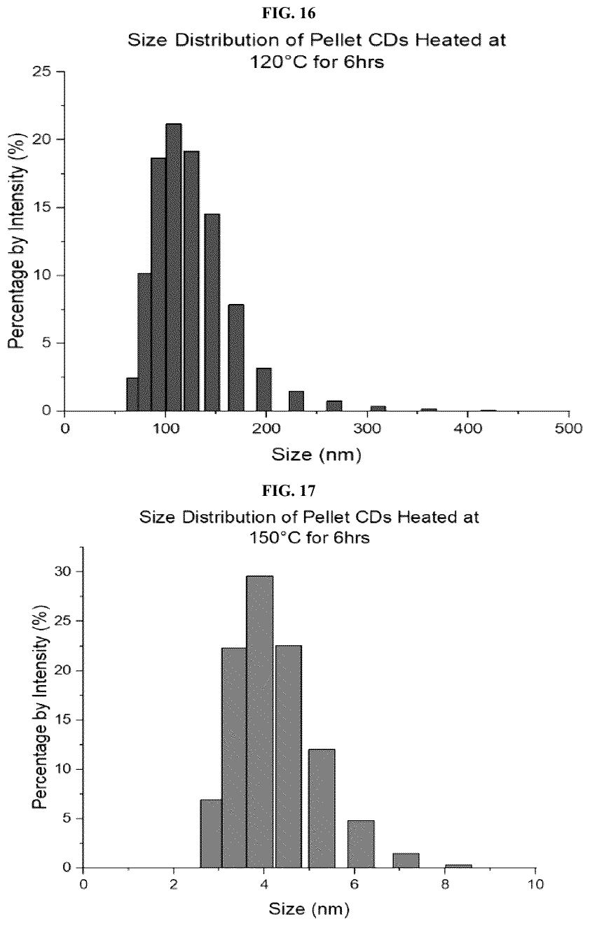

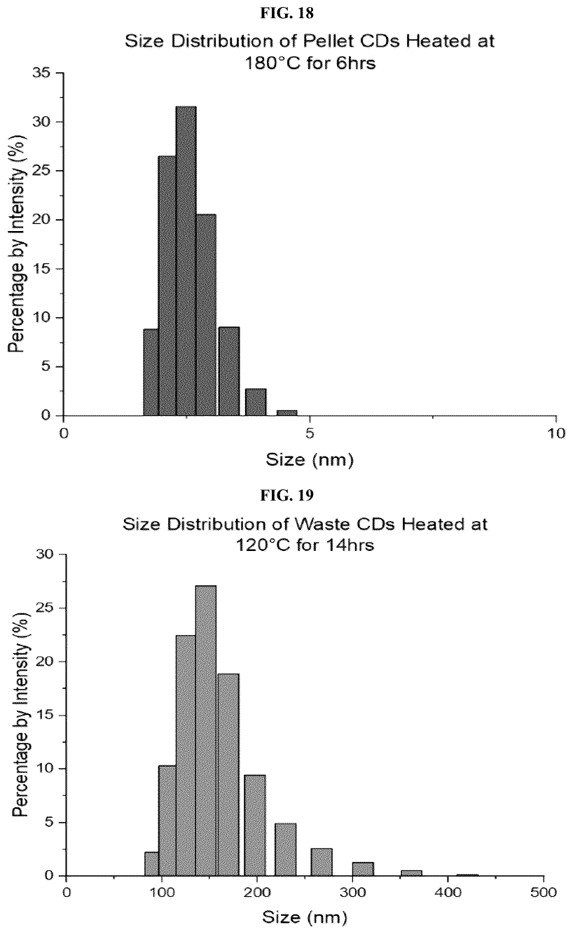

Dynamic light scattering was used to determine the size distributions of the various resultant CDs. Observed in FIG. 14, comparing the size distribution of all five solutions, a higher temperature produced smaller particles among the PP pellet-derived CDs. The average size of the CDs decreased from approximately 100 nm to 10 nm, 5 nm, and finally 3 nm, in order of increasing autoclaving temperature, from 120° C. for 6 hours to 120° C. for 14 hours, 150° C. for 6 hours, and 180° C. for 6 hours. This evidence suggests that higher autoclaving temperatures and longer autoclaving times result in smaller CD particles. This is most likely due to the increased energy that is absorbed by the CDs at higher temperatures, which has the potential to break more bonds and create smaller particles. This conclusion is also supported by FIGS. 15-18, which all display smaller particle sizes as autoclaving temperature and time increase. The data collected through DLS also shows that increased autoclaving temperature and time result in a narrower size distribution for PP pellet-derived CDs. This is seen in FIGS. 15-18, as the range of CD size decreases with increasing temperature and autoclaving time. FIG. 16, which plots the size distribution of the CDs autoclaved at 120° C. for 6 hours, displays a particle size ranging from approximately 60 nm to 360 nm, resulting in a particle size range of approximately 300 nm. As autoclaving temperature and time increase, the particle size range decreases to approximately 11 nm for FIG. 15 (120° C. for 14 hours), 5 nm for FIG. 17 (150° C. for 6 hours), and 3 nm for FIG. 18 (180° C. for 6 hours), clearly indicating that higher autoclaving temperatures and longer times create smaller CDs.

Finally, the data indicate that PP waste-derived CDs are much larger than their PP pellet-derived counterparts. As shown in FIG. 15, the PP pellet-derived CDs autoclaved at the same conditions as the waste-derived CDs (120° C. for 14 hours) had an average particle size of 10 nm. The waste-derived CDs, on the other hand, had an average particle size of approximately 140 nm. Additionally, it is evident from FIG. 15 and FIG. 19 that the particle size range in the waste-derived CDs, which is approximately 300 nm, is much larger than that of the pellet-derived CDs, which is approximately 10 nm. This difference may have been caused by a larger initial size of the waste PP particles, which were cut with scissors as opposed to the PP pellets which were sized consistently with industrial equipment. Still, the data suggest that PP waste-derived CDs have much larger particle sizes and size ranges than their pellet-derived counterparts.

### Example 4: Microscopy of Exemplary Carbon Dot (CD) Samples

### Optical Microscopy

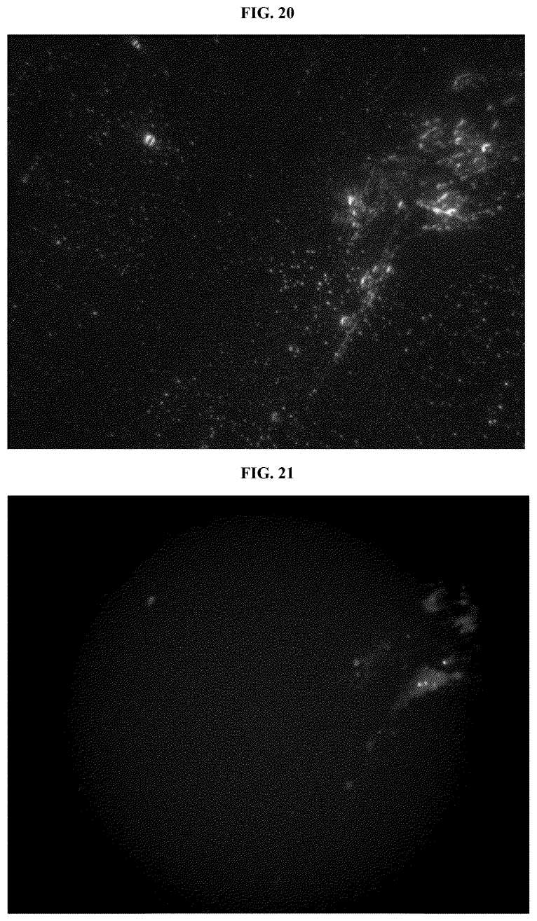

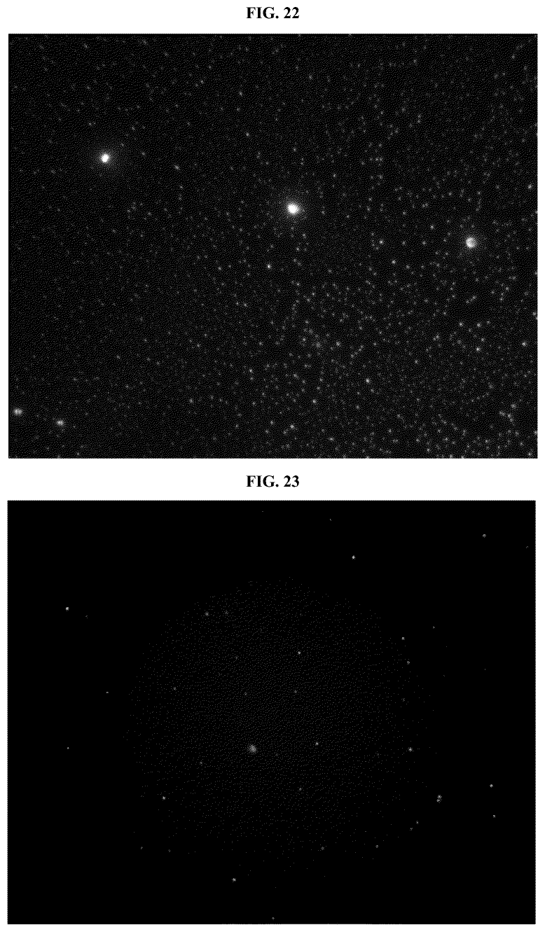

Microscopy was used to analyze the physical and optical properties of the produced CDs. FIG. 20 shows the pellet-derived CDs heated at 180° C. for 6 hours under dark field, on a statically spin-coated glass slide. The top right of the image indicates the presence of water droplets on the slide. FIG. 21 displays the same CDs under a 470 nm laser to test for fluorescence. The fluorescent CDs are seen as the sharp, bright points in the image, while the fluorophores can be seen as the duller, fluorescent particles in the background. FIG. 21 indicates the presence of fluorophores in the CDs. PP waste-derived CDs heated at 120° C. for 14 hours were also observed with microscopy on a statically spin-coated glass slide. FIG. 22 shows these CDs under dark field. These particles are visibly larger than those observed in FIG. 20, which supports the data found with dynamic light scattering (DLS). FIG. 23 shows the waste-derived CDs under a 470 nm laser. This image has sharp fluorescent points, proving the fluorescence exhibited by the waste-derived CDs.

### Scanning Electron Microscopy (SEM) and Transmission Electron Microscopy (TEM)

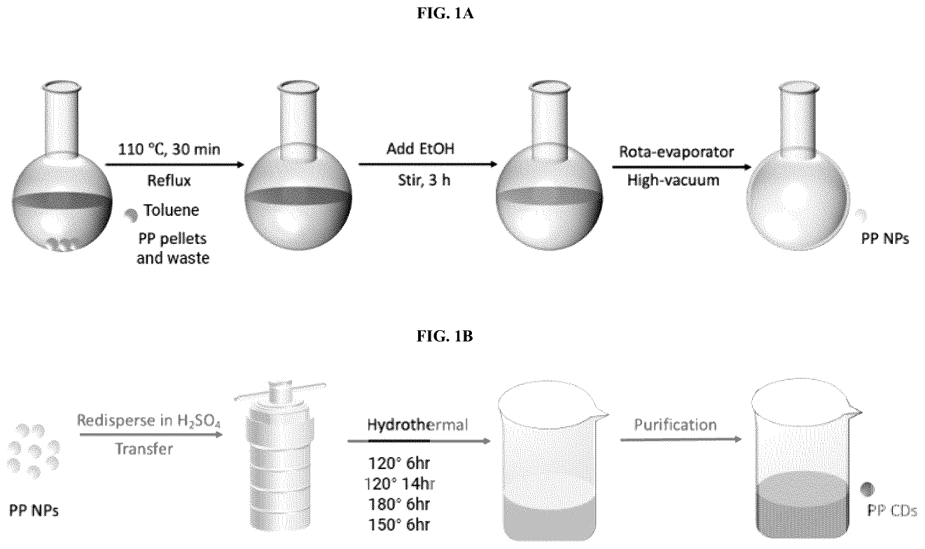

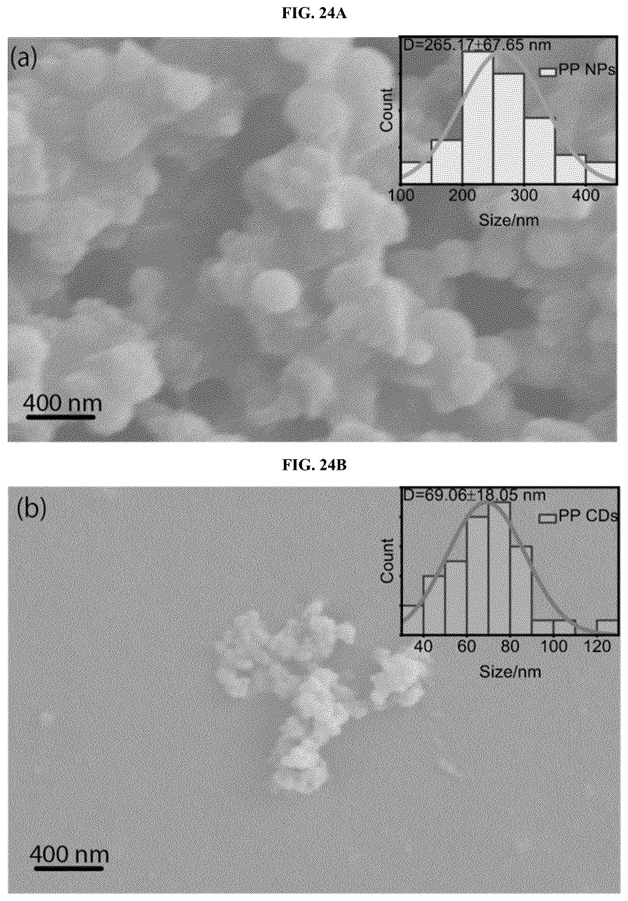

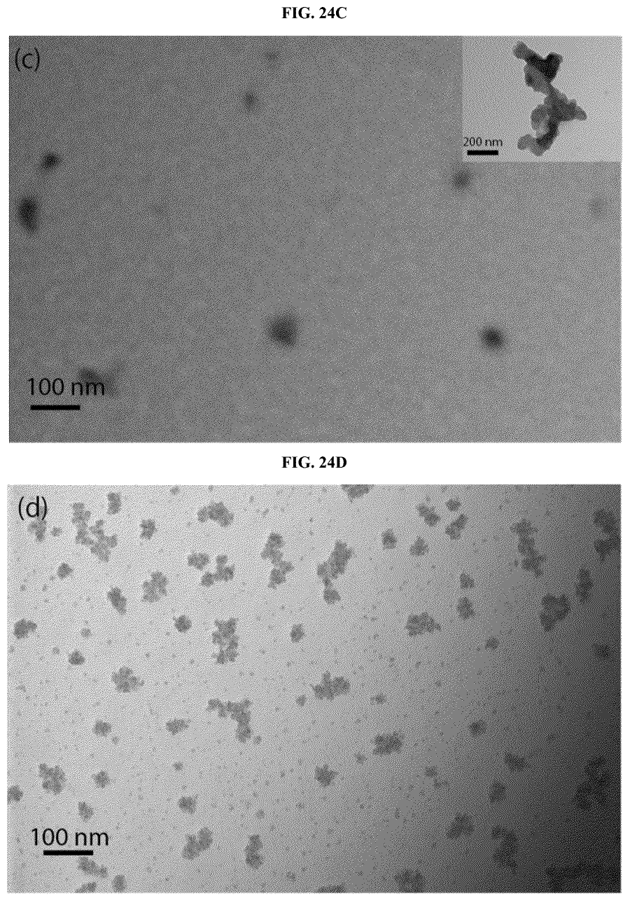

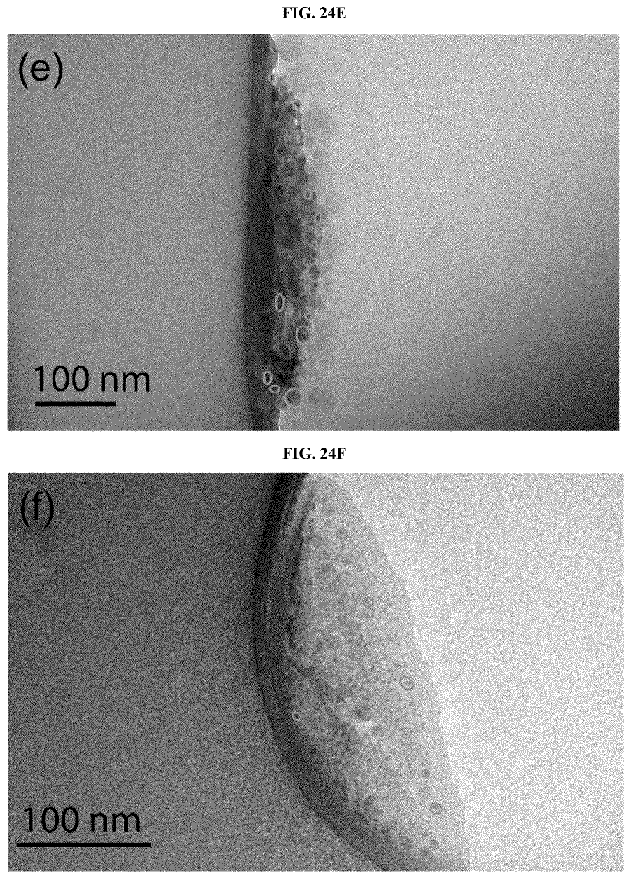

As indicated elsewhere herein, a two-step synthesis method is described herein which permits transformation of polypropylene pellets to luminescent carbon dots (PP-CDs). Polypropylene nanoplastics (PP NPs) were first prepared by a non-solvent induced phase separation (NIPS) method as the starting material as illustrated in FIG. 1A. PP-CDs were later obtained from a hydrothermal reaction of the premade nanoplastics at 120° C. for 6 hours as shown FIG. 1B. FIGS. 24A-24D shows the morphology and size study of the PP NPs and PP-CDs with scanning electron microscopy (SEM) and transmission electron microscopy (TEM). Large clusters of spherical particles were observed in FIGS. 24A-24B, while the inset histograms indicate the particle size decrease after the hydrothermal reaction with the mean size changing from 265.17±67.65 nm to 69.06±18.05 nm. Both single particles and clusters of nanoparticles were observed with TEM. It can also be concluded that the average size after the hydrothermal reaction is much smaller than that before the reaction (i.e., PP NPs).

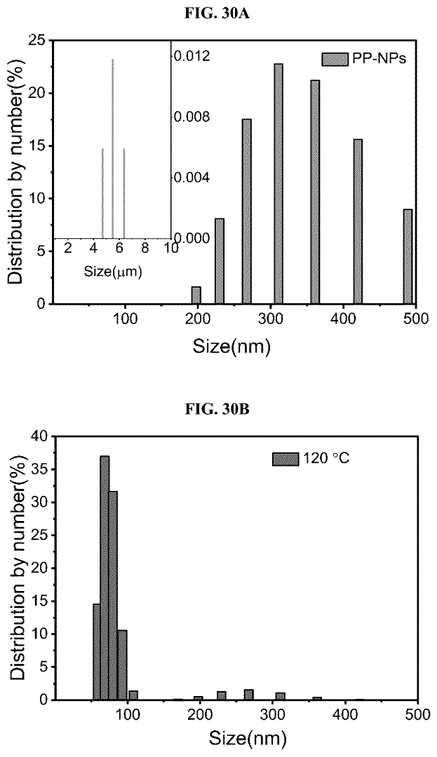

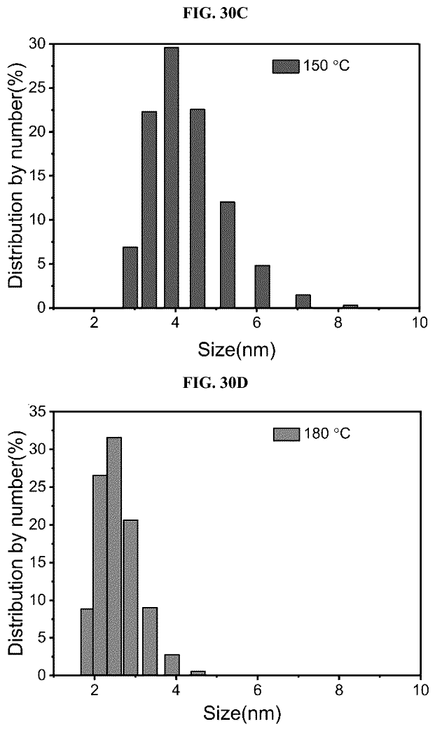

FIGS. 24A-24F show the morphology and size study of the PP-NPs and products from 120° C., 6 hours (PP-CDs-120) using SEM and TEM imaging. Large clusters of spherical particles were observed in both the PP-NPs and PP-CDs-120 samples, while the inset histograms indicate the particle size decreases after the hydrothermal reaction, with the mean size changing from 265±68 nm to 69±18 nm. Both single particles and clusters of nanoparticles were observed by TEM, as seen in FIG. 24C and FIG. 24D. The TEM images are consistent with the SEM images in that the average size after the hydrothermal reaction is much smaller than that before the reaction, i.e., PP-CDs are significantly smaller than PP-NPs. The polypropylene chain is broken into small segments and modified with functional groups under the strong acidic environment. It has been hypothesized that these segments form larger carbon networks by C—C bonding, which further evolve into a carbon particle. Dynamic light scattering (DLS) results also present a similar particle size distribution of PP-NPs (FIG. 30A). PP-NP sizes predominantly range from 198 nm to 489 nm. Two distribution peaks were observed in the DLS result of PP-CDs-120 as in FIG. 30B, with the first one between 50 nm to 108 nm and the second one between ˜200 nm to 400 nm. This can be explained by unreacted polypropylene residues left in the system as the size is close to the first particle size distribution in the PP-NPs.

### Example 5: Effects of Temperature on Carbonization

Different reaction conditions were explored to study the effect of temperature on the carbonization step, i.e., 150° C. and 180° C. The inset in FIG. 5 indicates that the PP-CDs size is decreased as temperature increases, and there is a narrower size distribution. A detailed histogram distribution of particles size is in FIGS. 29B-29D. The size of the particles occupying the highest percentage are 68.7 nm, 3.9 nm, and 2.5 nm for 120° C., 150° C. and 180° C., respectively, indicating a dramatic reduction in size at the higher temperatures. TEM images of CDs from 150° C. and 180° C. also indicates a decreasing particle size (FIGS. 24E-24F).

### Example 6: Chemical Composition of Exemplary PP-CDs

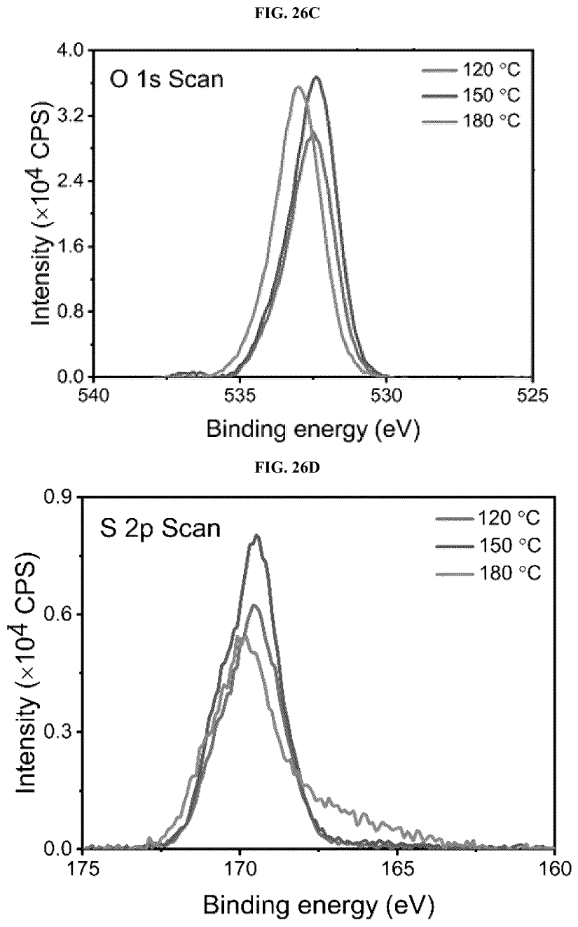

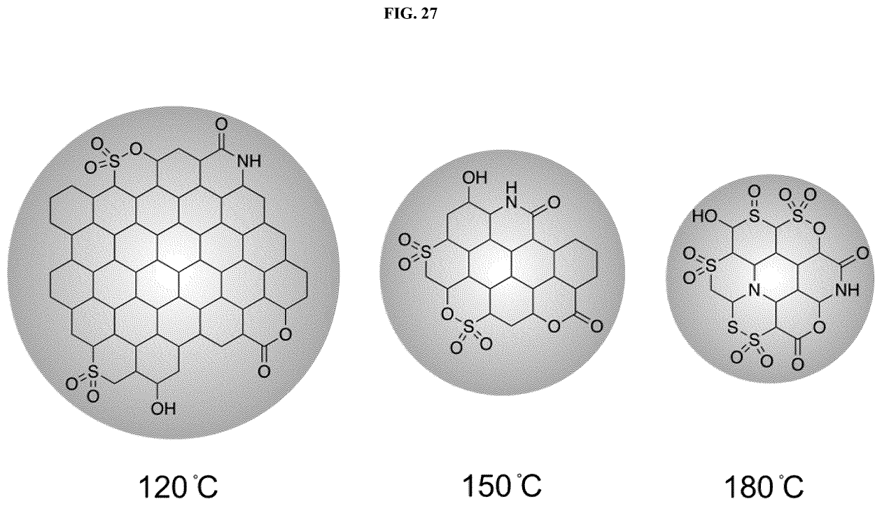

To study the chemical composition of the PP-CDs, FT-IR, Raman and XPS were employed to investigate the particles after dialysis. Comparing the PP-CDs FT-IR spectra to that of PP-NPs in FIG. 26A and FIG. 34, it is noted that the strong peak around 2952 cm⁻¹ in PP-NPs, which is assigned to the asymmetrical stretching of the —CH₃ group, was not observed in PP-CDs-180. Also, the symmetrical bending peaks of the —CH₃ group, 1457 cm⁻¹ and 1377 cm⁻¹, were not observed in the three PP-CDs spectra, which indicates the disappearance of PP. Meanwhile, new absorption peaks are observed in PP-CDs. The broad absorption around 3419 cm⁻¹ is the characteristic peak of the —OH/NH group, accompanied by a bending peak around 1417 cm⁻¹. The 1739 cm⁻¹ peak and 1649 cm⁻¹ peaks, are both assigned to the C—O bond, but from lactone and lactam, respectively. The peaks at 1174 cm⁻¹ and 1055 cm⁻¹ are assigned to C—O stretching, from ester and an alcohol, respectively. However, the sulfoxide structure also absorbs between 1030-1070 cm⁻¹, so it may also contribute to the peak around 1055 cm⁻¹. In addition, the 875 cm⁻¹ peak is assigned to C—H bending. With the normalization of the 875 cm⁻¹ peak, it is noted that the PP-CDs-180 has the lowest ratio of the C—O bond, CO bond and —OH group, while the PP-CDs-150 has the highest intensity of the —OH peak and C═O bond. These results indicate that the various functional groups detected by FT-IR are present in all the carbon dot products; however, there are slight differences in the amounts of the function groups on the carbon dots produced at the different temperatures. Overall, the FT-IR spectra confirm that the PP-NPs are fully transformed under the hydrothermal reaction temperature of 180° C. However, additional functional groups are also expected beyond what is detectable by FT-IR; see XPS results below.

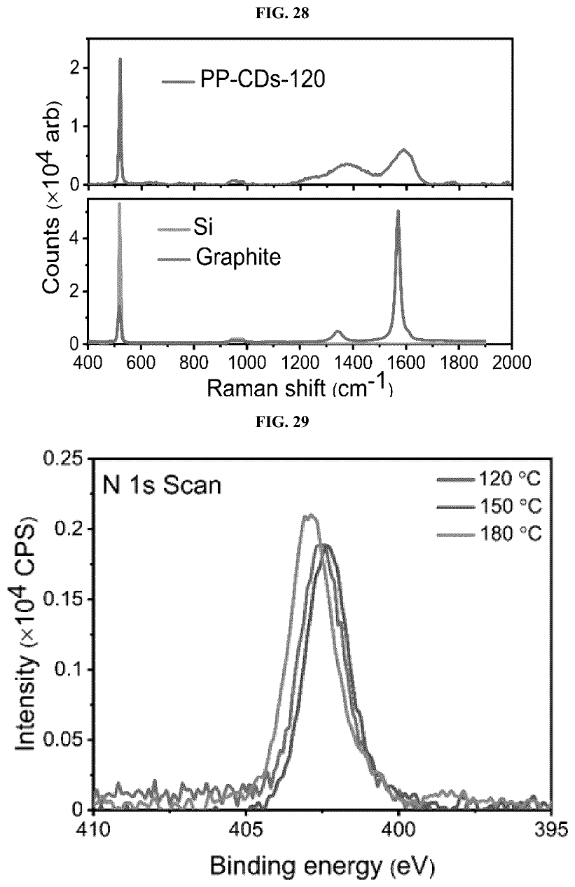

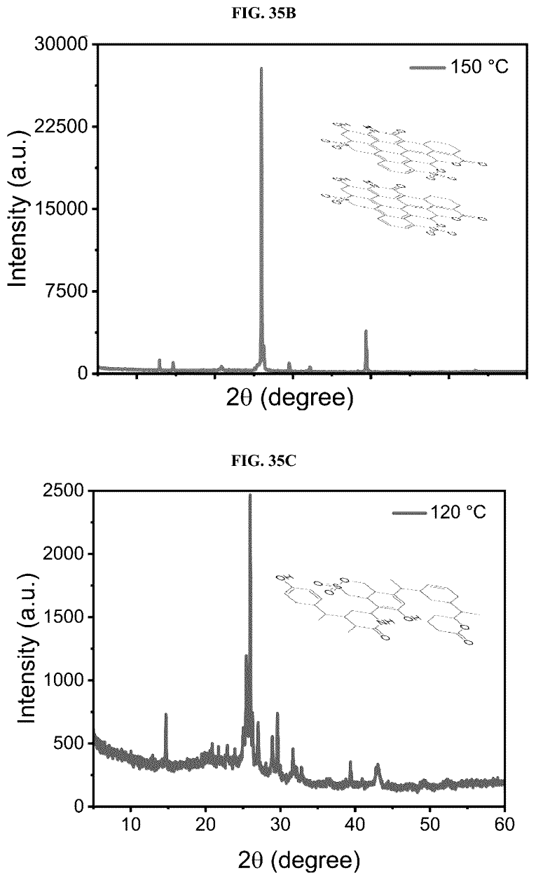

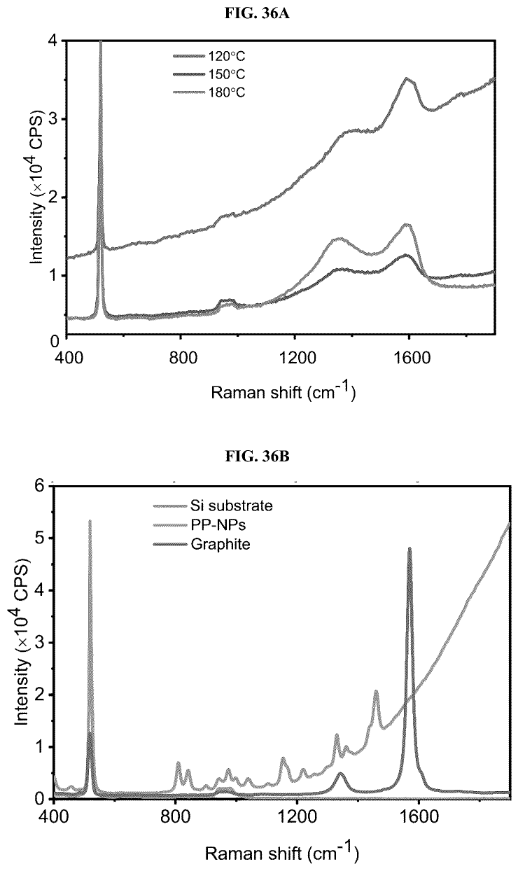

With the powder X-ray diffraction patterns in FIGS. 35A-35C, high crystallinity of PP-CDs from all three hydrothermal temperatures was observed. By analysis of the width of the primary PXRD peak, the crystallite size of the product from the 120° C. synthesis is close to the PP-CDs-120 particle size confirmed by DLS. The crystallite sizes of the products from the 150° C. and 180° C. syntheses are estimated to be larger than the DLS particle size at the corresponding temperature, which is attributed to stacking of single particles. Additionally, the products of the 150° C. and 180° C. syntheses are more crystalline compared to that of the 120° C. synthesis. The strong signal at around 25.9° is assigned to the (002) of graphitic structure. This indicates that the PP-derived carbon dots produced using our method exhibit a structure with a similar interlayer spacing as graphite. Raman spectroscopy was also performed on PP-CDs, graphite and PP-NPs as shown in FIG. 28 and FIGS. 36A-36B. D and G bands of PP-CDs-120 at 1370 cm⁻¹ and 1590 cm⁻¹, respectively, were also observed.

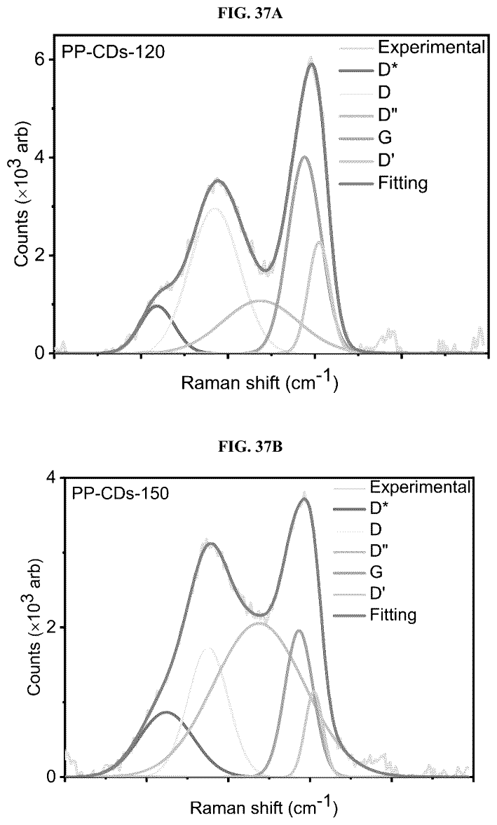

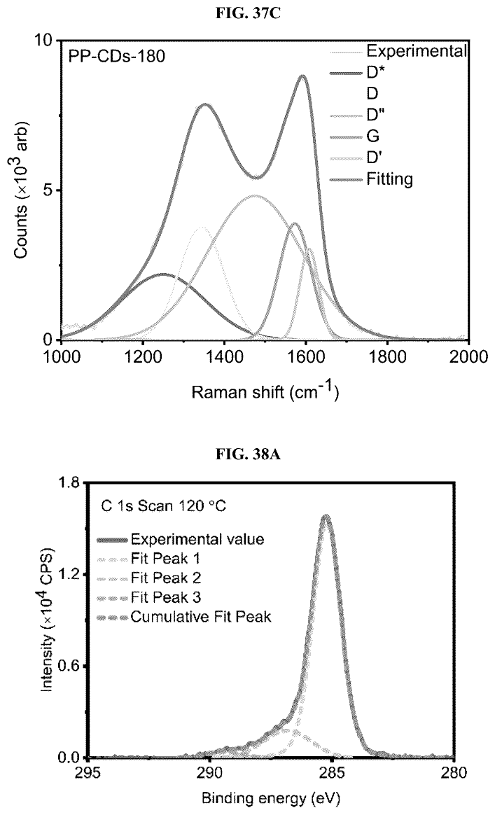

Compared to the Raman spectrum of a standard graphite sample, it is noted that the G band in PP-CDs-120 has a slight shift to a higher wavenumber, i.e., from 1571 cm⁻¹ to 1590 cm⁻¹ as a result of the increased contribution from the D′ peak centered ˜1610 cm⁻¹, which corresponds to the intra-valley resonance with the G band (FIGS. 37A-37C). Relatively low Raman signal was detected in PP-CDs samples obtained from higher hydrothermal temperatures, and the measurement was interfered by the strong fluorescence background of those samples.

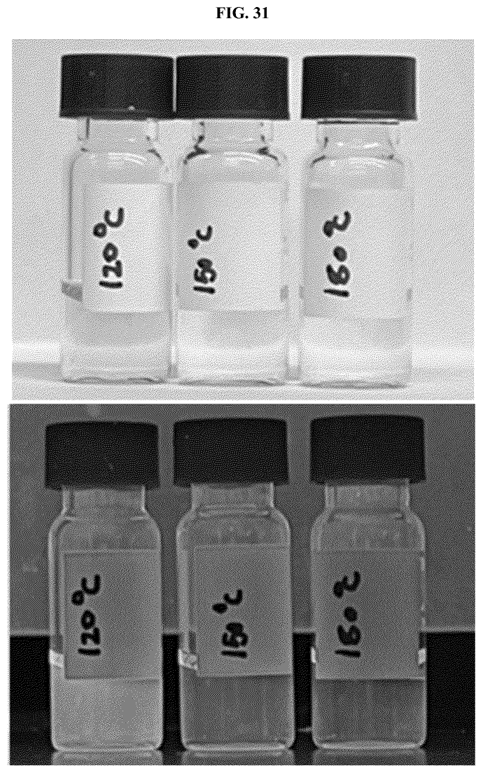

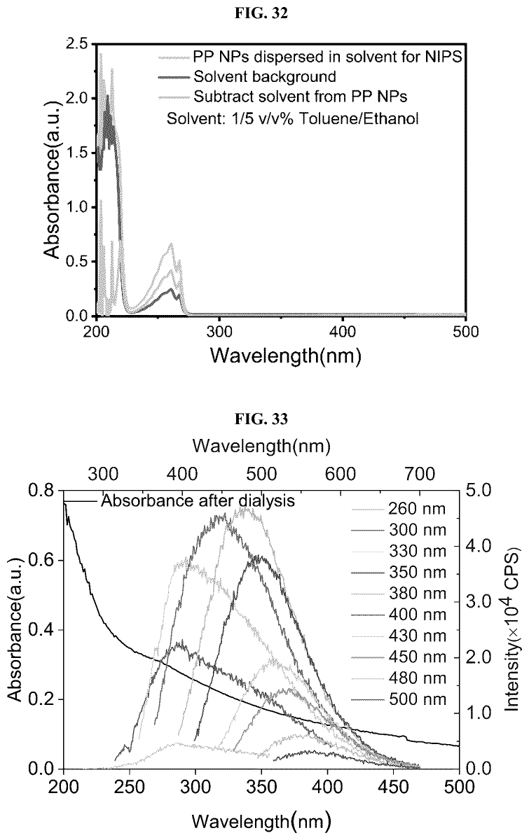

The XPS spectra of the three PP-CDs samples were also measured as shown in FIGS. 26B-26D and FIG. 32. PP-NPs and graphite were measured as well for comparison in the C Is scan. The calibrated atomic ratio of C, N, O and S elements is also calculated, as shown in Table 2. The percentage of carbon in PP-CDs has a clear decrease when the reaction temperature was increased to 150° C., while the oxygen, sulfur and nitrogen ratio increases when the temperature changes from 120° C. to 150° C. It is also noted that the PP-CDs-150 and PP-CDs-180 share similar atomic ratios of C, N, O, and S elements.

TABLE 2
Atomic percentage of each element in PP-CDs
for the different synthesis temperatures

| | Atomic Percentage (%) | | |
|---|---|---|---|
| Element | 120° C. | 150° C. | 180° C. |
| C | 86.24 | 74.60 | 75.98 |
| O | 10.20 | 19.00 | 17.31 |
| S | 2.62 | 5.00 | 4.41 |
| N | 0.94 | 1.40 | 2.30 |

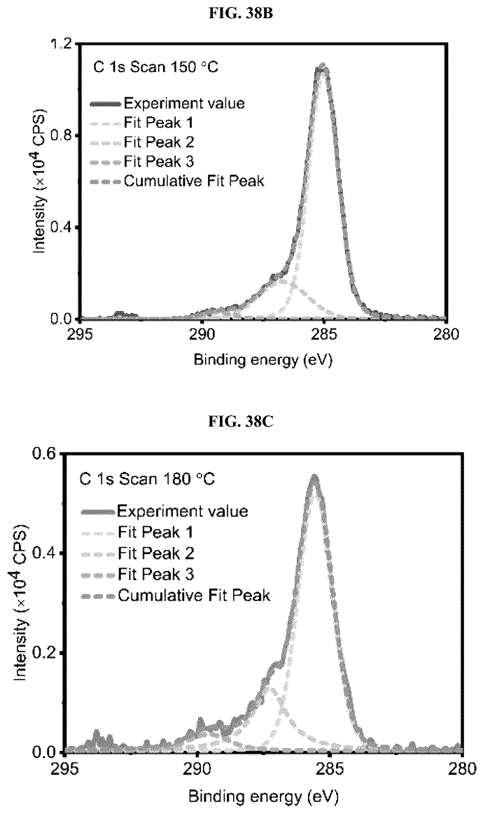

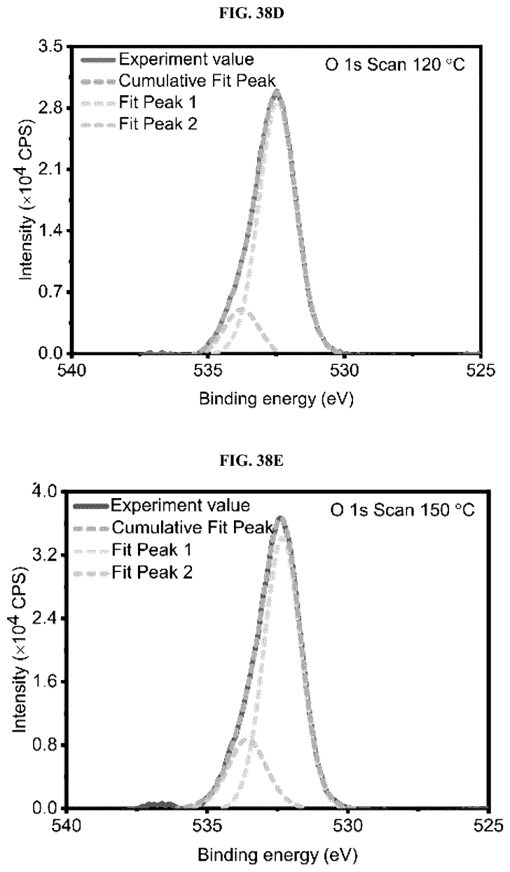

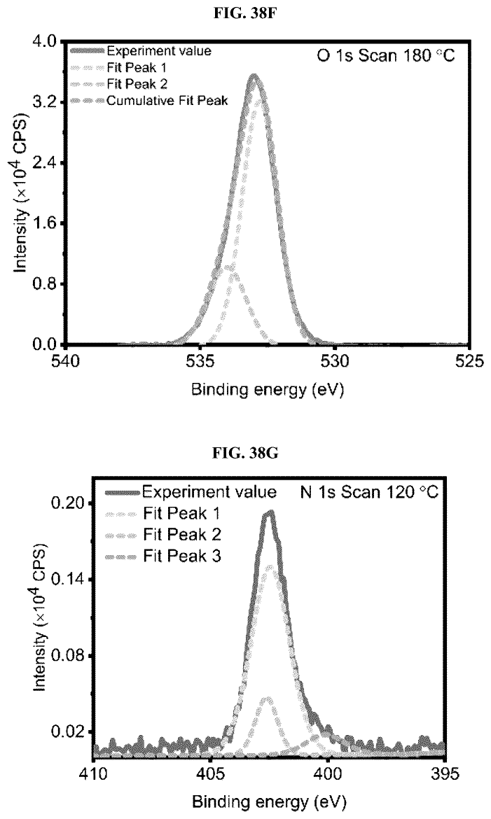

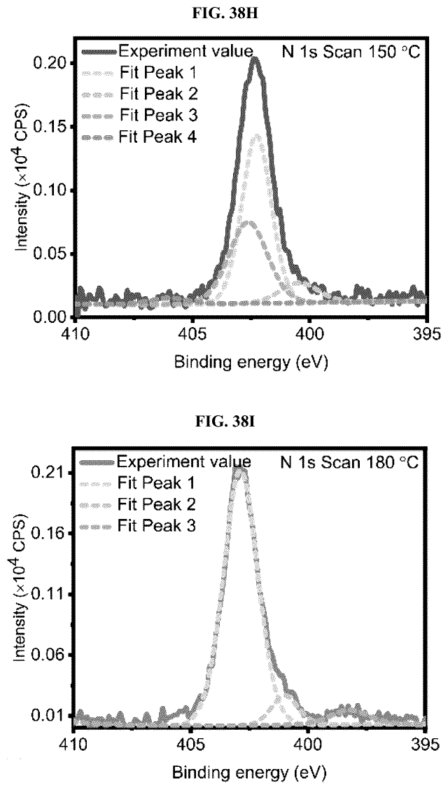

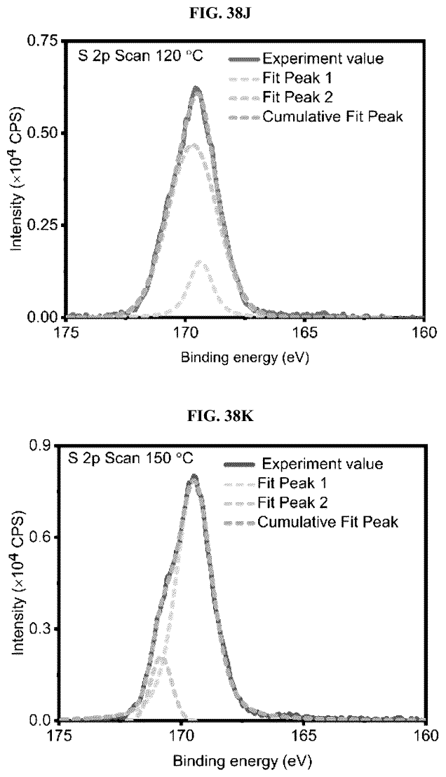

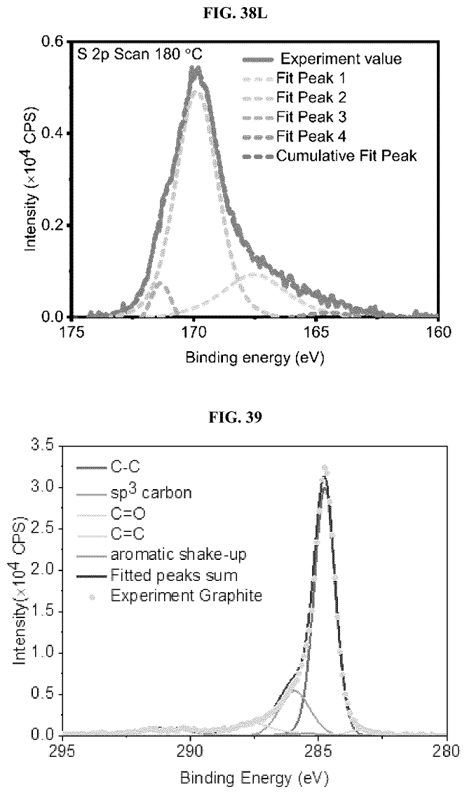

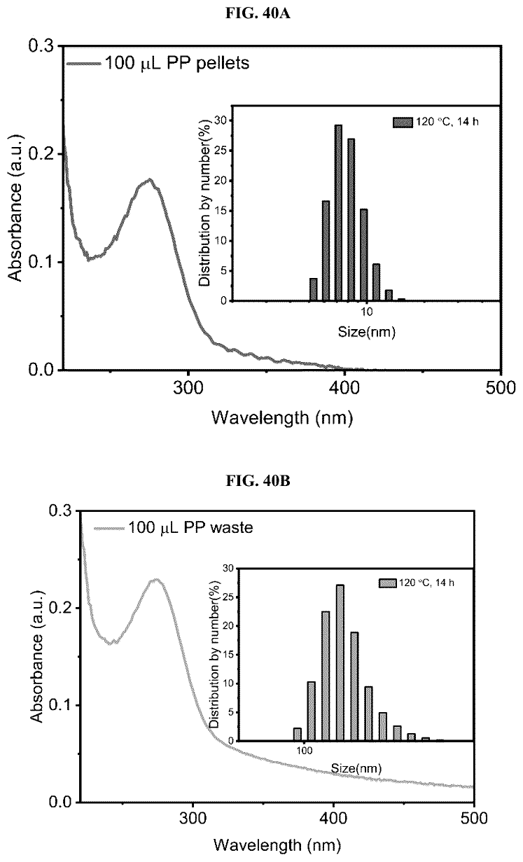

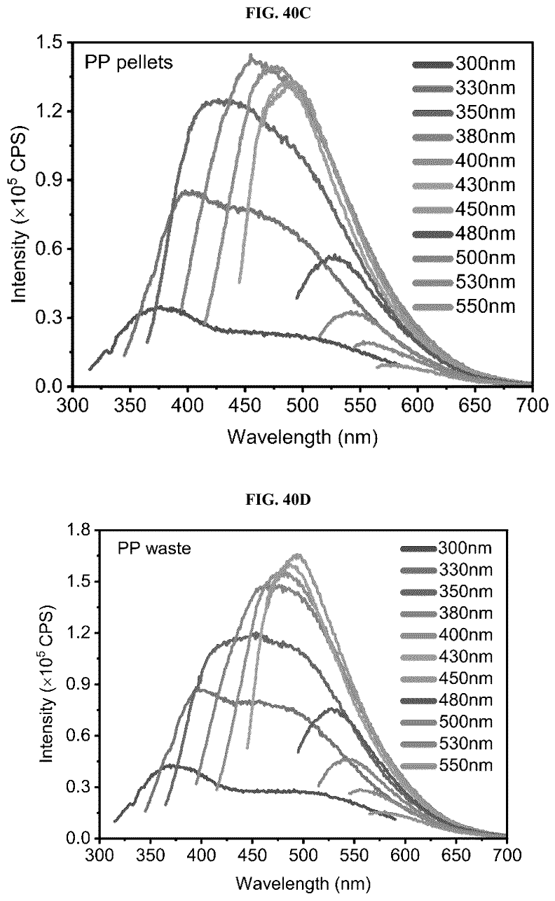

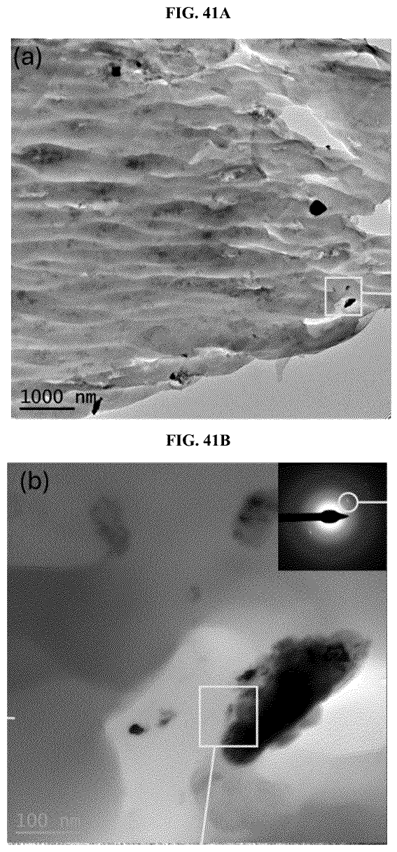

With the deconvolution of C 1s scan, as shown in FIGS. 38A-38L, the peak around 285.2 eV is assigned to sp³ carbon. The presence of sp³ carbon is consistent with the presence of the D* peak in the Raman spectra, which is not only detectable through peak fitting of all three samples but is also clearly visible as a shoulder in the D band of the PP-CDS-120 (FIGS. 37A-37C). Compared to the XPS spectra of commercial graphite powder (FIG. 39), whose sp² carbon bond peak centers at 284.8 eV, the sp³ hybridized carbon bond shifted towards a higher binding energy. The relative ratio of sp³ carbon decreases in the PP-CDs with increasing temperature (Table 3). The two peaks around 287 eV and 289 eV are assigned to C*—O—C/C*—OH (sp³) and C*OOH/C*OOC (sp²). In FIGS. 38D-38F, the O 1s scan indicates the existence of two forms of oxygen; the peak around 532.5 eV is assigned to C—O*H and another one around 534 eV is assigned to the COO*. The hydroxyl and ester structure are consistent with the functional groups found in FT-IR spectra. As shown in FIGS. 38J-38L, the dominant sulfur found in the three PP-CDs samples is the 6-fold coordinated sulfur, sulfonates and sulfones as suggested by the peak at 169-171 eV. However, two other formats of sulfur are found in PP-CDs-180, as indicated with the 167.5 eV and 164.5 eV peaks, which indicates a lower oxidation status, the sulfoxide structure (RS*(═O)R) and thiosulfinate structure (RS(═O)S*R).

TABLE 3
Relative fraction of the different forms of carbon calculated
based on XPS peak area for the different synthesis temperatures

| | Relative Fraction | | |
|---|---|---|---|
| Carbon Format | 120° C. | 150° C. | 180° C. |
| sp³ C | 0.818 | 0.788 | 0.693 |
| C*—O—C/C*—OH | 0.155 | 0.191 | 0.240 |
| C*OOH/C*OOC | 0.027 | 0.021 | 0.067 |

In addition, there is also a small percentage of N in the PP-derived CDs. Though the dominant N detected by the XPS is the N—O surface bond, as indicated by 402.5 eV, the C—NH₂ or C—NH is also present in PP-CDs. It is noted that there is another peak with a binding energy of 398.5 eV in PP-CDs-180 (FIG. 38I), which can be assigned to the N-substituted graphite structure. Nitrogen doping could provide defects in the carbon-core and, thus, enhance the luminescence based on previous studies. The detailed XPS deconvolution results are included in Tables 4-6.

TABLE 4
Element ratio of PP-CDs-120

| Scan Name | Peak BE/eV | Area | Adjusted R² |
|---|---|---|---|
| C1s Scan A | 285.21 ± 0.00 | 24272.31 ± 509.50 | 0.99947 |
| C1s Scan B | 286.82 ± 0.09 | 4599.20 ± 641.09 | |
| C1s Scan C | 289.36 ± 0.16 | 813.63 ± 200.72 | |
| O1s Scan A | 532.46 ± 0.03 | 55329.78 ± 2290.44 | 0.99776 |
| O1s Scan B | 533.76 ± 0.15 | 10526.31 ± 2290.51 | |
| S2p Scan A | 169.36 ± 0.02 | 2426.92 ± 1197.70 | 0.99733 |
| S2p Scan B | 169.69 ± 0.02 | 12229.55 ± 917.35 | |
| N1s Scan A | 402.48 | 3055.76 | |
| N1s Scan B | 402.58 | 538.28 | |
| N1s Scan C | 400.08 | 320.49 | |

TABLE 5
Element ratio of PP-CDs-150

| Scan Name | Peak BE/e V | Area | Adjusted R² |
|---|---|---|---|
| C1s Scan A | 285.04 ± 0.01 | 17079.72 ± 529.02 | 0.99854 |
| C1s Scan B | 286.70 ± 0.12 | 4143.04 ± 610.02 | |
| C1s Scan C | 289.35 ± 0.16 | 462.56 ± 137.18 | |
| O1s Scan A | 532.33 ± 0.03 | 61130.29 ± 3387.96 | 0.99771 |
| O1s Scan B | 533.58 ± 0.14 | 20564.21 ± 3474.74 | |
| S2p Scan A | 169.48 ± 0.009 | 16847.85 ± 214.41 | 0.99838 |
| S2p Scan B | 170.82 ± 0.02 | 2268.50 ± 140.91 | |
| N1s Scan A | 402.28 | 2065.33 | |
| N1s Scan B | 400.48 | 316.72 | |
| N1s Scan C | 402.58 | 1310.29 | |
| N1s Scan C | 406.08 | 91.25 | |

TABLE 6
Element ratio of PP-CDs-180

| Scan Name | Peak BE/eV | Area | Adjusted R² |
|---|---|---|---|
| C1s Scan A | 285.55 ± 0.01 | 8875.89 ± 282.40 | 0.9942 |
| C1s Scan B | 287.27 ± 0.04 | 3074.83 ± 403.49 | |
| C1s Scan C | 289.58 ± 0.13 | 864.73 ± 314.45 | |
| O1s Scan A | 532.78 ± 0.06 | 54800.95 ± 5781.66 | 0.99562 |
| O1s Scan B | 534.01 ± 0.21 | 18897.55 ± 6014.48 | |
| S2p Scan A | 169.88 ± 0.02 | 12654.15 ± 7116.29 | 0.99499 |
| S2p Scan B | 171.34 ± 0.05 | 894.38 ± 1311.81 | |
| S2p Scan C | 167.52 ± 0.53 | 5435.37 ± 12047.79 | |
| S2p ScanD | 164.51 ± 1.44 | 1225.78 ± 4096.05 | |
| N1s Scan A | 402.88 | 3849.69 | |
| N1s Scan B | 400.98 | 347.16 | |
| N1s Scan C | 398.28 | 242.72 | |

It has been hypothesized herein that the structure of the PP-CDs in FIG. 27 based on the chemical composition characterization results. According to the FT-IR results, there is an indication that some PP is not fully converted in the 120° C. sample. This is attributed to the larger size of these particles leading to presence of unreacted PP in the core and carbonized product near the surface. For the higher temperature syntheses, there is no evidence of PP in the FT-IR spectra, indicating full conversion of the PP. Based on the PXRD data, all of the three carbon dot products exhibit graphite-like ordered regions, while the samples from 150° C. and 180° C. appear to be more crystalline than that from 120° C. Additionally, based on the FT-IR, Raman and XPS spectroscopy data, the carbonized product from 120° C. has the highest relative fraction of sp³ carbon, while the product from 180° C. has the highest relative fraction of sp² carbon in ester structure and the highest variety of functional groups. Therefore, the structure of the PP-CDs from the 120° C. synthesis is depicted as having larger size, lower crystallinity and a lower degree of unsaturation compared to the PP-CDs at higher temperature (FIG. 27, left). In contrast, the PP-CDs prepared at 150° C. and 180° C. are smaller in size, more ordered/crystalline, have a higher degree of oxidation and a greater variety of functional groups (FIG. 27, middle and right).

### Example 7: Post-Processing of PP-Derived CDs

In certain embodiments, the methods of preparing and purifying PP-derived CDs (e.g., removing unreacted plastic materials and/or other intermediates), as described elsewhere herein, may be performed in conjunction with an additional post-processing step. In certain embodiments, the purification methods described elsewhere herein include iterative dilution with deionized water (e.g., 5 times volume), centrifugation thereof (e.g., at 17,000 g for 30 minutes), and dialysis (e.g., for 40-48 h).

In certain embodiments, a post-processing method may be performed to alter the properties of the resultant PP-derived CDs. In certain embodiments, the post-processing method comprises one or more iterative steps comprising a drying step, a redispersion step, and a subsequent redrying step. In one aspect, the disclosure relates to the unexpected discovery that the resultant product(s) have much larger crystalline size compared to the original carbon dot product (i.e., before post-processing). Without wishing to be bound by any theory, it has been hypothesized herein that the post-processing method facilitates a self-assembly of the carbon dots into a high order/dimensional structure.

As indicated elsewhere here, in certain embodiments, the post-processing method comprises an initial drying step, a redispersion step, and a redrying step.

In certain embodiments, the initial drying step comprises at least one freeze drying step, air drying step, heat drying step, and/or vacuum drying step.

Freeze drying: the PP-derived CDs were lyophilized after dialysis. The dialyzed solution was transferred to a centrifuge tube. After applying the lyophilization technique, a powder was obtained.

Air drying: The dialyzed solution was transferred to vials. The vials were left open and solutions were exposed to ambient air in a fume hood. When exposed to the air during the drying process, there is a possibility to increase the oxygen percentage of the material.

Heat drying: The dialyzed solution was transferred to vials. A gentle heat was applied to the vials to accelerate the water evaporation and assist the drying process. The environment during the heat drying process is also ambient air in a fume hood.

Vacuum drying: In certain embodiments, the ideal drying process without any external energy input is to leave the vials in the vacuum overnight at room temperature.

In certain embodiments, the redispersion step occurs after one of the drying steps. In one non-limiting, exemplary embodiment, the redispersion was performed by adding dropwise to a container comprising the dried material water, ethylene glycol, and/or another solvent. In certain embodiments, a 3-minute sonication was employed to facilitate dispersion of the material. In certain embodiments, the amount of solvent used depends upon the container type (e.g., vial or centrifuge tube). In certain embodiments, a concentrated solution is preferred (e.g., 200 μL on the scale described herein).

In certain embodiments, the redrying step occurs after the redispersion step. In certain embodiments, suspended material is drop-cast on different substrates (e.g., silicon, carbon tape, and grid). In certain embodiments, the drop-cast substrates were allowed to dry overnight under vacuum.

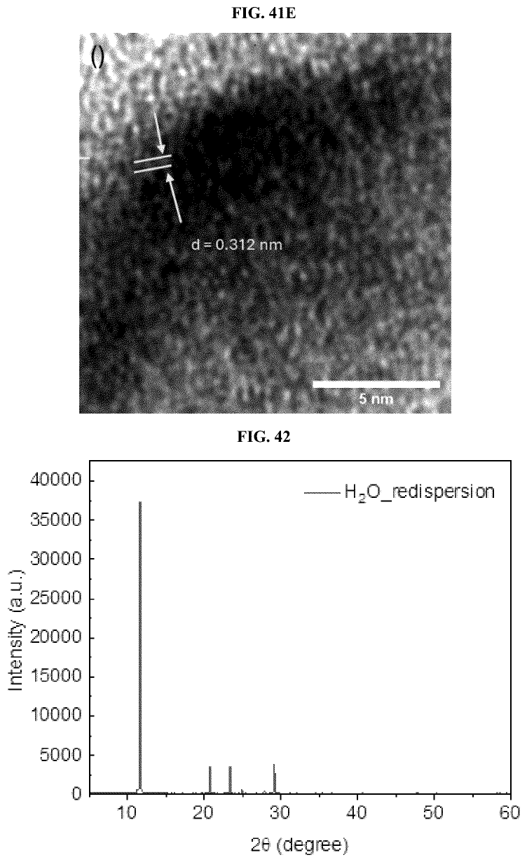

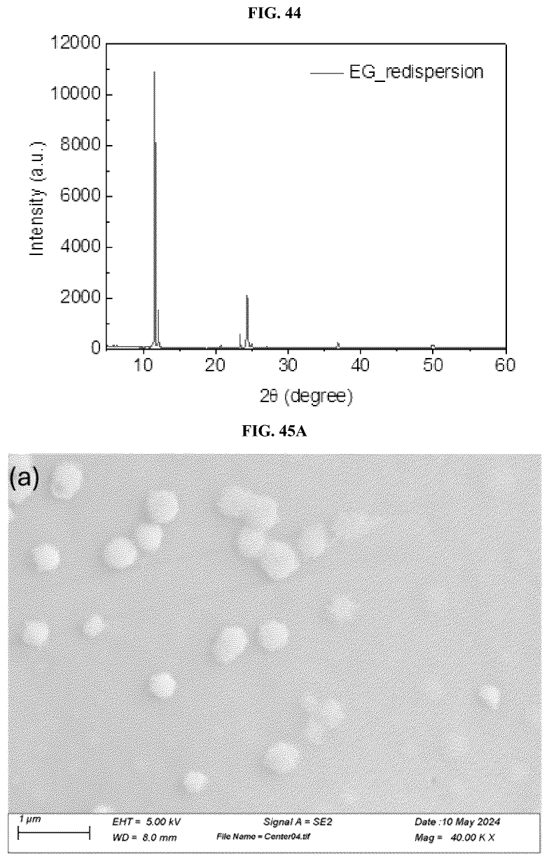

In certain embodiments, non-limiting exemplary data obtained from experiments (e.g., PXRD and SEM, inter alia) using materials subjected to the post-processing method described herein indicated that the materials possess altered, and in certain embodiments, favorable properties (FIGS. 35A-35C, FIGS. 41A-41E, FIG. 42, FIGS. 43A-43B, FIG. 44, and FIGS. 45A-45B). In one non-limiting example, powder x-ray diffraction (PXRD) of exemplary freeze-dried, redispersed, and dried samples indicated that the post-process of products from 150° C. and 180° C. reactions exhibited high crystallinity and graphitic-like structures (FIGS. 35A-35C).

### Enumerated Embodiments

The following exemplary embodiments are provided, the numbering of which is not to be construed as designating levels of importance:

Embodiment 1 provides a method for preparing a carbon nanomaterial from a plastic material, the method comprising:
(a) heating a first mixture comprising a plastic material and a first solvent to provide a first solution,
   wherein the first solvent comprises a nonpolar or low polarity solvent;
(b) contacting the first solution with a polar solvent to provide a second mixture;
(c) isolating plastic nanoparticles from the second mixture by removing at least a portion of the solvent in the second mixture;
(d) suspending the isolated plastic nanoparticles in an oxidizing solvent to provide a third mixture; and
(e) heating the third mixture in a sealed vessel to provide a fourth mixture comprising the carbon nanomaterial,
   wherein the heating of the third mixture occurs at a temperature ranging from about 100° C. to about 200° C. for a period of about 1 h to about 24 h.

Embodiment 2 provides the method of Embodiment 1, wherein the plastic material comprises at least one selected from the group consisting of polypropylene (PP), polyethylene terephthalate (PET), polyethylene (PE), polyurethane (PU), and polystyrene (PS), optionally wherein the plastic material is a waste material.

Embodiment 3 provides the method of Embodiment 1 or 2, wherein the first solvent consists essentially of the nonpolar or low polarity solvent.

Embodiment 4 provides the method of Embodiment 3, wherein the nonpolar or low polarity solvent is at least one selected from the group consisting of toluene, benzene, 1,2-dimethylbenzene, 1,3-dimethylbenzene, 1,4-dimethylbenzene, and mixtures thereof.

Embodiment 5 provides the method of any one of Embodiments 1-4, wherein the heating of the first mixture occurs at a temperature of about 75° C. to about 145° C.

Embodiment 6 provides the method of Embodiment 5, wherein the nonpolar or low polarity solvent is toluene and the heating occurs at a temperature of about 110° C.

Embodiment 7 provides the method of any one of Embodiments 1-6, wherein the first solution has a total dissolved and/or suspended concentration of plastic material of about 1 mg/mL to about 25 mg/mL.

Embodiment 8 provides the method of any one of Embodiments 1-7, wherein the first solution has a dissolved or suspended concentration of plastic material of about 6.5 mg/mL.

Embodiment 9 provides the method of Embodiment 8, wherein the polar solvent is an alcohol.

Embodiment 10 provides the method of Embodiment 9, wherein the alcohol is ethanol.

Embodiment 11 provides the method of any one of Embodiments 1-10, wherein the polar solvent and first solution have a volume ratio ranging from about 1:1 to about 10:1.

Embodiment 12 provides the method of any one of Embodiments 1-11, wherein the polar solvent and first solution have a ratio of about 5:1.

Embodiment 13 provides the method of any one of Embodiments 1-12, wherein the second mixture is agitated at room temperature.

Embodiment 14 provides the method of any one of Embodiments 1-13, wherein the step of removing at least a portion of the solvent in the second mixture comprises at least one selected from the group consisting of evaporation at reduced pressure, filtration, and centrifugation.

Embodiment 15 provides the method of Embodiment 14, wherein the evaporation at reduced pressure occurs by rotary evaporation (i.e., reduced pressure of about 20 mbar to about 200 mbar).

Embodiment 16 provides the method of Embodiment 14 or 15, wherein the evaporation at reduced pressure further comprises exposure to high vacuum (i.e., reduced pressure of about 10⁻³ mbar to about 10⁻⁷ mbar).

Embodiment 17 provides the method of any one of Embodiments 1-16, wherein the oxidizing solvent comprises an acid selected from the group consisting of H₂SO₄, HNO₃, H₃PO₄, HCl, and mixtures thereof.

Embodiment 18 provides the method of Embodiment 17, wherein the H₂SO₄, HNO₃, H₃PO₄, or HCl are concentrated.

Embodiment 19 provides the method of any one of claims 1-18, wherein the oxidizing solvent is the acid.

Embodiment 20 provides the method of any one of Embodiments 1-19, wherein the heating of the third mixture comprises heating at a temperature of about 120° C. for a period of about 6 h.

Embodiment 21 provides the method of any one of Embodiments 1-19, wherein the heating of the third mixture comprises heating at a temperature of about 120° C. for a period of about 14 h.

Embodiment 22 provides the method of any one of Embodiments 1-19, wherein the heating of the third mixture comprises heating at a temperature of about 150° C. for a period of about 6 h.

Embodiment 23 provides the method of any one of Embodiments 1-19, wherein the heating of the third mixture comprises heating at a temperature of about 150° C. for a period of about 14 h.

Embodiment 24 provides the method of any one of Embodiments 1-19, wherein the heating of the third mixture comprises heating at a temperature of about 180° C. for a period of about 6 h.

Embodiment 25 provides the method of any one of Embodiments 1-19, wherein the heating of the third mixture comprises heating at a temperature of about 180° C. for a period of about 14 h.

Embodiment 26 provides the method of any one of Embodiments 1-25, wherein the method further comprises purification of the carbon nanomaterial.

Embodiment 27 provides the method of any one of Embodiments 1-26, wherein the carbon nanomaterial is luminescent.

Embodiment 28 provides the method of Embodiment 26, wherein the isolation of the carbon nanomaterial comprises:
(f) diluting the fourth mixture with water to provide a fifth mixture;
(g) centrifuging the fifth mixture to provide a supernatant;
(h) filtering the supernatant using a filter having a pore size of less than about 1.0 μm to provide a filtrate; and
(i) subjecting the filtrate to dialysis to provide the isolated carbon nanomaterial.

Embodiment 29 provides the method of any one of Embodiments 26-28, wherein the method further comprises post-processing of the carbon nanomaterial.

Embodiment 30 provides the method of Embodiment 29, wherein the post-processing comprises:
(j) subjecting the isolated carbon nanomaterial to a first drying step to provide a dried carbon nanomaterial;
(k) redispersing the dried carbon nanomaterial in a suitable solvent to provide a redispersed carbon nanomaterial; and
(l) subjecting the redispersed carbon nanomaterial to a second drying step.

Embodiment 31 provides the method of Embodiment 30, wherein the first drying step is selected from the group consisting of a freeze drying process, an air drying process, a heat drying process, and a vacuum drying process.

Embodiment 32 provides the method of Embodiment 30 or 31, wherein the suitable solvent comprises at least one solvent selected from the group consisting of water and ethylene glycol,

Embodiment 33 provides the method of any one of Embodiments 30-32, wherein the redispersed carbon nanomaterial has a concentration of about 1 mg/mL to about 50 mg/mL.

Embodiment 34 provides the method of any one of Embodiments 30-33, wherein the second drying step comprises distributing the redispersed carbon nanomaterial as a film on a substrate surface,

Embodiment 35 provides the method of any one of Embodiments 30-34, wherein any solvent is removed by heating, exposure to vacuum, and/or exposure to air.

Embodiment 36 provides the method of any one of Embodiments 1-35, wherein the carbon nanomaterial comprises a carbon dot.

Embodiment 37 provides the method of any one of Embodiments 1-36, wherein the carbon nanomaterial is luminescent.

Embodiment 38 provides the method of Embodiment 36 or 37, wherein the carbon dot has a diameter ranging from about 1.0 nm to about 400 nm.

Embodiment 39 provides the method of Embodiment 38, wherein the carbon dot has a diameter ranging from about 1.5 nm to about 5.3 nm.

Embodiment 40 provides the method of any one of Embodiments 36-39, wherein the carbon dot is at least partially doped with at least one selected from the group consisting of oxygen, sulfur, and nitrogen.

Embodiment 41 provides the method of any one of Embodiments 36-40, wherein the carbon dot is substantially free of the plastic material.

Embodiment 42 provides a carbon nanomaterial prepared according to the method of Embodiment 1.

Embodiment 43 provides the carbon nanomaterial depicted in any one of FIGS. 20-23.

Embodiment 44 provides the carbon nanomaterial depicted in any one of FIGS. 24A-24F.

Embodiment 45 provides the carbon nanomaterial characterized according to any one of FIGS. 35A-35C.

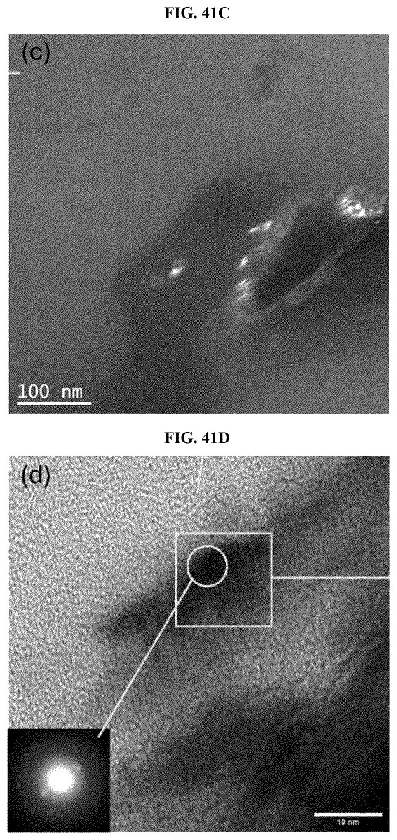

Embodiment 46 provides the carbon nanomaterial depicted in any one of FIGS. 41A-41E.

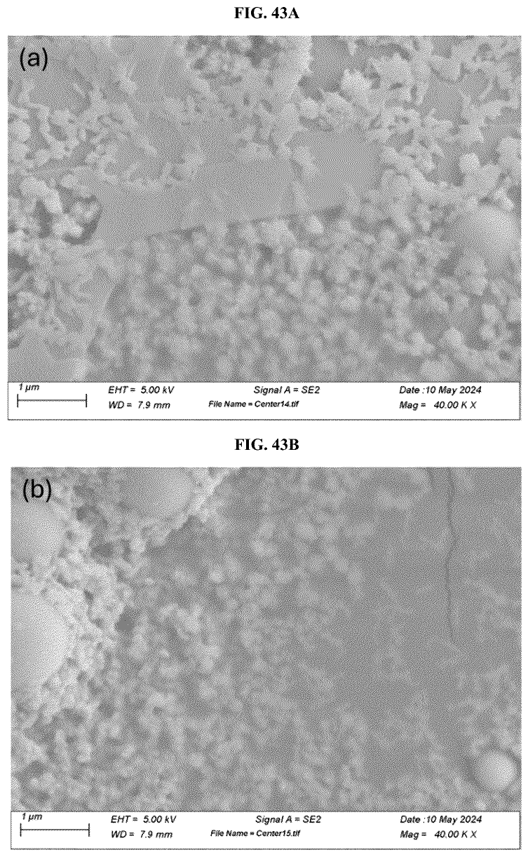

Embodiment 47 provides the carbon nanomaterial depicted in any one of FIGS. 43A-43B.

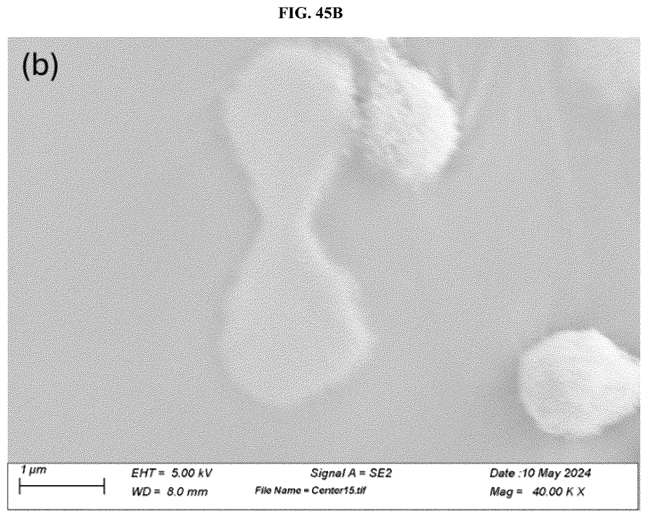

Embodiment 48 provides the carbon nanomaterial depicted in any one of FIGS. 45A-45B.

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

What is claimed is:

1. A method for preparing a carbon nanomaterial from a plastic material, the method comprising:
(a) heating a first mixture comprising a plastic material and a first solvent to provide a first solution,
wherein the first solvent comprises a nonpolar or low polarity solvent;
(b) contacting the first solution with a polar solvent to provide a second mixture;
(c) isolating plastic nanoparticles from the second mixture by removing at least a portion of the solvent in the second mixture;
(d) suspending the isolated plastic nanoparticles in an oxidizing solvent to provide a third mixture; and
(e) heating the third mixture in a sealed vessel to provide a fourth mixture comprising the carbon nanomaterial,
wherein the heating of the third mixture occurs at a temperature ranging from about 100° C. to about 200° C. for a period of about 1 h to about 24 h.

2. The method of claim 1, wherein the plastic material comprises at least one selected from the group consisting of polypropylene (PP), polyethylene terephthalate (PET), polyethylene (PE), polyurethane (PU), and polystyrene (PS), optionally wherein the plastic material is a waste material.

3. The method of claim 1, wherein the first solvent consists essentially of the nonpolar or low polarity solvent, optionally wherein the nonpolar or low polarity solvent is at least one selected from the group consisting of toluene, benzene, 1,2-dimethylbenzene, 1,3-dimethylbenzene, 1,4-dimethylbenzene, and mixtures thereof.

4. The method of claim 1, wherein the heating of the first mixture occurs at a temperature of about 75° C. to about 145° C., optionally wherein the nonpolar or low polarity solvent is toluene and the heating occurs at a temperature of about 110° C.

5. The method of claim 1, wherein at least one of the following applies:
(a) the first solution has a total dissolved and/or suspended concentration of plastic material of about 1 mg/mL to about 25 mg/mL, optionally wherein the first solution has a dissolved or suspended concentration of plastic material of about 6.5 mg/ml;
(b) the polar solvent is an alcohol, optionally wherein the alcohol is ethanol;
(c) the polar solvent and first solution have a volume ratio ranging from about 1:1 to about 10:1, optionally wherein the polar solvent and first solution have a ratio of about 5:1; or
(d) the second mixture is agitated at room temperature.

6. The method of claim 1, wherein the step of removing at least a portion of the solvent in the second mixture comprises at least one selected from the group consisting of evaporation at reduced pressure, filtration, and centrifugation, optionally wherein the evaporation at reduced pressure occurs by rotary evaporation (i.e., reduced pressure of about 20 mbar to about 200 mbar), optionally wherein the evaporation at reduced pressure further comprises exposure to high vacuum (i.e., reduced pressure of about 10⁻³ mbar to about 10⁻⁷ mbar).

7. The method of claim 1, wherein the oxidizing solvent comprises an acid selected from the group consisting of H₂SO₄, HNO₃, H₃PO₄, HCl, and mixtures thereof, optionally wherein the H₂SO₄, HNO₃, H₃PO₄, or HCl are concentrated, and optionally wherein the oxidizing solvent is the acid.

8. The method of claim 1, wherein the heating of the third mixture comprises one of the following:
(a) heating at a temperature of about 120° C. for a period of about 6 h;
(b) heating at a temperature of about 120° C. for a period of about 14 h;
(c) heating at a temperature of about 150° C. for a period of about 6 h;
(d) heating at a temperature of about 150° C. for a period of about 14 h;
(e) heating at a temperature of about 180° C. for a period of about 6 h; or
(f) heating at a temperature of about 180° C. for a period of about 14 h.

9. The method of claim 1, wherein the method further comprises purification of the carbon nanomaterial, optionally wherein the carbon nanomaterial is luminescent.

10. The method of claim 9, wherein the isolation of the carbon nanomaterial comprises:
(f) diluting the fourth mixture with water to provide a fifth mixture;
(g) centrifuging the fifth mixture to provide a supernatant;
(h) filtering the supernatant using a filter having a pore size of less than about 1.0 μm to provide a filtrate; and
(i) subjecting the filtrate to dialysis to provide the isolated carbon nanomaterial.

11. The method of claim 10, wherein the method further comprises post-processing of the carbon nanomaterial.

12. The method of claim 11, wherein the post-processing comprises:
(j) subjecting the isolated carbon nanomaterial to a first drying step to provide a dried carbon nanomaterial;
(k) redispersing the dried carbon nanomaterial in a suitable solvent to provide a redispersed carbon nanomaterial; and
(l) subjecting the redispersed carbon nanomaterial to a second drying step.

13. The method of claim 12, wherein the first drying step is selected from the group consisting of a freeze drying process, an air drying process, a heat drying process, and a vacuum drying process.

14. The method of claim 12, wherein the suitable solvent comprises at least one solvent selected from the group consisting of water and ethylene glycol, optionally wherein the redispersed carbon nanomaterial has a concentration of about 1 mg/mL to about 50 mg/mL.

15. The method of claim 12, wherein the second drying step comprises distributing the redispersed carbon nanomaterial as a film on a substrate surface, optionally wherein any solvent is removed by heating, exposure to vacuum, and/or exposure to air.

16. The method of claim 1, wherein the carbon nanomaterial comprises a carbon dot.

17. The method of claim 16, wherein the carbon dot has a diameter ranging from about 1.0 nm to about 400 nm, optionally wherein the carbon dot has a diameter ranging from about 1.5 nm to about 5.3 nm.

18. The method of claim 16, wherein the carbon dot is at least partially doped with at least one selected from the group consisting of oxygen, sulfur, and nitrogen.

19. The method of claim 16, wherein the carbon dot is substantially free of the plastic material.

20. A carbon nanomaterial prepared according to the method of claim 1.
